(19) United States
(12) Patent Application Publication
(10) Pub. No.: US 2026/0339068 A1
(43) Pub. Date: Oct. 29, 2026

(54) LENS ASSEMBLY

(71) Applicant: Asia Optical Co., Inc., Taichung (TW)

(72) Inventor: Yan-Jie Syu, Taichung (TW)

(21) Appl. No.: 19/557,320

(22) Filed: Mar. 5, 2026

(30) Foreign Application Priority Data
Apr. 28, 2025 (TW) 114115943

(51) Int. Cl. G02B 9/34

(52) U.S. Cl. CPC G02B 9/34

(57) ABSTRACT

A lens assembly includes a first lens group, a second lens group, a third lens group, and a fourth lens group, all of which are arranged in order from an object side to an image side along an optical axis. The first lens group is with positive refractive power and includes a 1-1 lens, a 1-2 lens, a 1-3 lens, and a 1-4 lens, all of which are arranged in order from the object side to the image side along the optical axis. The second lens group is with negative refractive power and includes a 2-2 lens. The third lens group is with positive refractive power and includes a 3-3 lens and a 3-4 lens, both of which are arranged in order from the object side to the image side along the optical axis. The fourth lens group is with positive refractive power and includes a 4-1 lens.

### BACKGROUND OF THE INVENTION

### Field of the Invention

The invention relates to a lens assembly.

### Description of the Related Art

Current iris recognition technology is not popularized yet because it requires a short recognition distance and it requires the eyes of human to approach the lens assembly for successful recognition. Therefore, the lens assembly needs a new structure to increase the recognition distance for iris recognition.

### BRIEF SUMMARY OF THE INVENTION

The invention provides a lens assembly to solve the above problems. The lens assembly of the invention is provided with characteristics of a large aperture and zoom function, which can improve the recognition distance of iris recognition when applied to iris recognition.

The lens assembly in accordance with an exemplary embodiment of the invention includes a first lens group, a second lens group, a third lens group, and a fourth lens group, all of which are arranged in order from an object side to an image side along an optical axis. The first lens group is with positive refractive power and includes a 1-1 lens, a 1-2 lens, a 1-3 lens, and a 1-4 lens, wherein the 1-1 lens is with positive refractive power and includes a concave surface facing the image side and being the lens closest to the object side, the 1-2 lens is adjacent to the 1-1 lens and has positive refractive power, the 1-3 lens is with refractive power and includes a convex surface facing the object side, the 1-4 lens is with refractive power and includes a concave surface facing the image side, and the 1-1 lens, the 1-2 lens, the 1-3 lens, and the 1-4 lens are arranged in order from the object side to the image side along the optical axis. The second lens group is with negative refractive power and includes a 2-2 lens, wherein the 2-2 lens is with negative refractive power and includes a concave surface facing the object side. The third lens group is with positive refractive power and includes a 3-3 lens and a 3-4 lens, wherein the 3-3 lens is with positive refractive power, the 3-4 lens is a biconcave lens with negative refractive power and includes a concave surface facing the object side and another concave surface facing the image side, and the 3-3 lens and the 3-4 lens are arranged in order from the object side to the image side along the optical axis. The fourth lens group is with positive refractive power and includes a 4-1 lens, wherein the 4-1 lens is a biconvex lens with positive refractive power and includes a convex surface facing the object side and another convex surface facing the image side.

In another exemplary embodiment, the third lens group further includes a 3-1 lens and a 3-2 lens; the 3-1 lens is the lens closest to the object side among the third lens group and the 3-4 lens is the lens closest to the image side among the third lens group; the 3-1 lens is a biconvex lens with positive refractive power and includes a convex surface facing the object side and another convex surface facing the image side, the 3-2 lens is a meniscus lens, and the 3-3 lens is a meniscus lens; and the 3-2 lens is adjacent to the 3-3 lens and is disposed between the 3-1 lens and the 3-3 lens.

In yet another exemplary embodiment, the second lens group further includes a 2-1 lens which is with negative refractive power and comprises a convex surface facing the object side and is disposed between the 2-2 lens and the object side.

In another exemplary embodiment, the 1-1 lens is a meniscus lens which is closest to the object side and the 1-1 lens further includes a convex surface facing the object side; the 1-2 lens is a meniscus lens; and there is an air gap among the 1-1 lens, the 1-2 lens, and the 1-3 lens.

In yet another exemplary embodiment, the third lens group further includes a 3-1 lens and a 3-2 lens; the 3-1 lens is the lens closest to the object side among the third lens group and the 3-4 lens is the lens closest to the image side among the third lens group; the 3-1 lens is a biconvex lens with positive refractive power and includes a convex surface facing the object side and another convex surface facing the image side, the 3-2 lens is a meniscus lens, and the 3-3 lens is a meniscus lens; the 3-2 lens is adjacent to the 3-3 lens and is disposed between the 3-1 lens and the 3-3 lens; and the second lens group further includes a 2-1 lens which is with negative refractive power and includes a convex surface facing the object side and is disposed between the 2-2 lens and the object side.

In another exemplary embodiment, the 1-2 lens includes a convex surface facing the object side and a concave surface facing the image side; there is no air gap among the 1-3 lens and the 1-4 lens or the 1-3 lens and the 1-4 lens are cemented, and the combination of the 1-3 lens and the 1-4 lens is with negative refractive power; the 2-1 lens is a meniscus lens and further includes a concave surface facing the image side; the 3-2 lens is a meniscus lens with positive refractive power and includes a convex surface facing the object side and a concave surface facing the image side; the 3-3 lens is a meniscus lens and includes a convex surface facing the object side and a concave surface facing the image side; the lens groups include at least seven meniscus lenses; and the second lens group moves along the optical axis toward the image side and the fourth lens group moves along the optical axis toward the object side or the image side when the lens assembly zooms, and the fourth lens group is the lens group closest to the image side.

In yet another exemplary embodiment, the 2-2 lens is a meniscus lens or a biconcave lens; the 2-2 lens further includes a convex surface facing the image side when the 2-2 lens is a meniscus lens; and the 2-2 lens further includes another concave surface facing the image side when the 2-2 lens is a biconcave lens.

In another exemplary embodiment, the lens assembly further includes a meniscus lens which is with positive refractive power and includes a convex surface facing the object side and a concave surface facing the image side and is disposed between the 2-1 lens and the 2-2 lens, or between the 3-3 lens and the 3-4 lens.

In yet another exemplary embodiment, the second lens group further includes a 2-3 lens which is a biconvex lens with positive refractive power and includes a convex surface facing the object side and another convex surface facing the image side and is disposed between the 2-1 lens and the 2-2 lens.

In another exemplary embodiment, the lens assembly satisfies at least one of the following conditions: −92 mm⁻¹≤(rb/dc)/fw≤2 mm⁻¹; −1.5≤(db−fa)/rb≤0.8; −7.4≤(ra−rc)/ft≤5.4; −9.76≤rc/(f3g−fc)≤−0.76; 10≤(ft−fw)/dc≤26; −7.5 mm≤ft/(f34/dc)≤−2 mm; −15.7≤(rc/fa)−fw≤−1.7; −104 mm≤(fc/Y)×f4g≤−60 mm; 3.8≤ft/fw≤4.9; −30 mm≤(ra/fb)×dc≤1.5 mm; wherein rb is a radius of curvature of an image side surface of the lens which is between the object side and a stop and closest to the stop, dc is an interval along the optical axis from an image side surface of the lens which is among the third lens group and second closest to the image side to an object side surface of the lens which is among the third lens group and closest to the image side, db is an interval from an image side surface of the 4-1 lens to an image plane along the optical axis when the lens assembly is at a telephoto end, fa is an effective focal length of the 2-1 lens, rc is a radius of curvature of the object side surface of the lens which is closest to the image side and among the third lens group, ft is an effective focal length of the lens assembly when the lens assembly is at the telephoto end, f3g is an effective focal length of the third lens group, fc is an effective focal length of the lens which is closest to the image side and among the second lens group, fw is an effective focal length of the lens assembly when the lens assembly is at a wide-angle end, f34 is a combined effective focal length of the combination of the 1-3 lens and the 1-4 lens, Y is a maximum image height of the lens assembly, f4g is an effective focal length of the fourth lens group, ra is a radius of curvature of an image side surface of the lens which is with positive refractive power and among the second lens group, and fb is an effective focal length of the lens which is with positive refractive power and among the second lens group.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a lens assembly in accordance with a first embodiment of the invention;

FIG. 2 is a lens layout and optical path diagram of a lens assembly in accordance with a second embodiment of the invention;

FIG. 3 depicts a longitudinal aberration diagram of the lens assembly at a wide-angle end in accordance with the second embodiment of the invention;

FIG. 4 depicts a field curvature diagram of the lens assembly at the wide-angle end in accordance with the second embodiment of the invention;

FIG. 5 depicts a distortion diagram of the lens assembly at the wide-angle end in accordance with the second embodiment of the invention;

FIG. 6 depicts a longitudinal aberration diagram of the lens assembly at a telephoto end in accordance with the second embodiment of the invention;

FIG. 7 depicts a field curvature diagram of the lens assembly at the telephoto end in accordance with the second embodiment of the invention;

FIG. 8 depicts a distortion diagram of the lens assembly at the telephoto end in accordance with the second embodiment of the invention;

FIG. 9 is a lens layout and optical path diagram of a lens assembly in accordance with a third embodiment of the invention;

FIG. 10 depicts a longitudinal aberration diagram of the lens assembly at a wide-angle end in accordance with the third embodiment of the invention;

FIG. 11 depicts a field curvature diagram of the lens assembly at the wide-angle end in accordance with the third embodiment of the invention;

FIG. 12 depicts a distortion diagram of the lens assembly at the wide-angle end in accordance with the third embodiment of the invention;

FIG. 13 depicts a longitudinal aberration diagram of the lens assembly at a telephoto end in accordance with the third embodiment of the invention;

FIG. 14 depicts a field curvature diagram of the lens assembly at the telephoto end in accordance with the third embodiment of the invention;

FIG. 15 depicts a distortion diagram of the lens assembly at the telephoto end in accordance with the third embodiment of the invention;

FIG. 16 is a lens layout and optical path diagram of a lens assembly in accordance with a fourth embodiment of the invention;

FIG. 17 depicts a longitudinal aberration diagram of the lens assembly at a wide-angle end in accordance with the fourth embodiment of the invention;

FIG. 18 depicts a field curvature diagram of the lens assembly at the wide-angle end in accordance with the fourth embodiment of the invention;

FIG. 19 depicts a distortion diagram of the lens assembly at the wide-angle end in accordance with the fourth embodiment of the invention;

FIG. 20 depicts a longitudinal aberration diagram of the lens assembly at a telephoto end in accordance with the fourth embodiment of the invention;

FIG. 21 depicts a field curvature diagram of the lens assembly at the telephoto end in accordance with the fourth embodiment of the invention;

FIG. 22 depicts a distortion diagram of the lens assembly at the telephoto end in accordance with the fourth embodiment of the invention; and

FIG. 23 is a lens layout and optical path diagram of a lens assembly in accordance with a fifth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens group, a second lens group, a third lens group, and a fourth lens group. The first lens group, the second lens group, the third lens group, and the fourth lens group are arranged in order from an object side to an image side along an optical axis. The first lens group is with positive refractive power and includes a 1-1 lens, a 1-2 lens, a 1-3 lens, and a 1-4 lens, wherein the 1-1 lens is with positive refractive power and includes a concave surface facing the image side, a convex surface facing the object side and being the lens closest to the object side, the 1-2 lens is adjacent to the 1-1 lens and has positive refractive power, and can be a biconvex lens, a meniscus lens (convex concave or concave convex), or a plano-convex lens (plane convex or convex plane), the 1-3 lens is with positive or negative refractive power and includes a convex surface facing the object side, and a concave surface, a convex surface, or a plane surface facing the image side, the 1-3 lens is not a biconcave lens when the refractive power of the 1-3 lens is positive and the 1-3 lens is not a biconvex lens or a plano-convex lens when the refractive power of the 1-3 lens is negative, the 1-4 lens is with positive or negative refractive power and includes a concave surface facing the image side, and a concave surface, a convex surface, or a plane surface facing the object side, the 1-4 lens is not a biconcave lens or a plano-concave lens when the refractive power of the 1-4 lens is positive and the 1-4 lens is not a biconvex lens when the refractive power of the 1-4 lens is negative. The 1-1 lens, the 1-2 lens, the 1-3 lens, and the 1-4 lens are arranged in order from the object side to the image side along the optical axis. The second lens group is with negative refractive power and includes a 2-2 lens, wherein the 2-2 lens is with negative refractive power and includes a concave surface facing the object side, and a concave surface, a convex surface, or a plane surface facing the image side. The third lens group is with positive refractive power and includes a 3-3 lens and a 3-4 lens, wherein the 3-3 lens is with positive refractive power and can be a biconvex lens, a meniscus lens (convex concave or concave convex), or a plano-convex lens (plane convex or convex plane), the 3-4 lens is a biconcave lens with negative refractive power and includes a concave surface facing the object side and another concave surface facing the image side, and the 3-3 lens and the 3-4 lens are arranged in order from the object side to the image side along the optical axis. The fourth lens group is with positive refractive power and includes a 4-1 lens, wherein the 4-1 lens is a biconvex lens with positive refractive power and includes a convex surface facing the object side and another convex surface facing the image side. A lens assembly of the present invention can achieve the basic function when the lens assembly satisfies the above features and does not require other additional features or conditions.

Referring to Table 1, Table 2, Table 4, Table 5, Table 7, Table 8, Table 10, Table 11, Table 13, and Table 14, wherein Table 1, Table 4, Table 7, Table 10, and Table 13 show optical specification in accordance with a first, a second, a third, a fourth, and a fifth embodiments of the invention, respectively, and Table 2, Table 5, Table 8, Table 11, and Table 14 show aspheric coefficients of each aspheric lens in Table 1, Table 4, Table 7, Table 10, and Table 13, respectively.

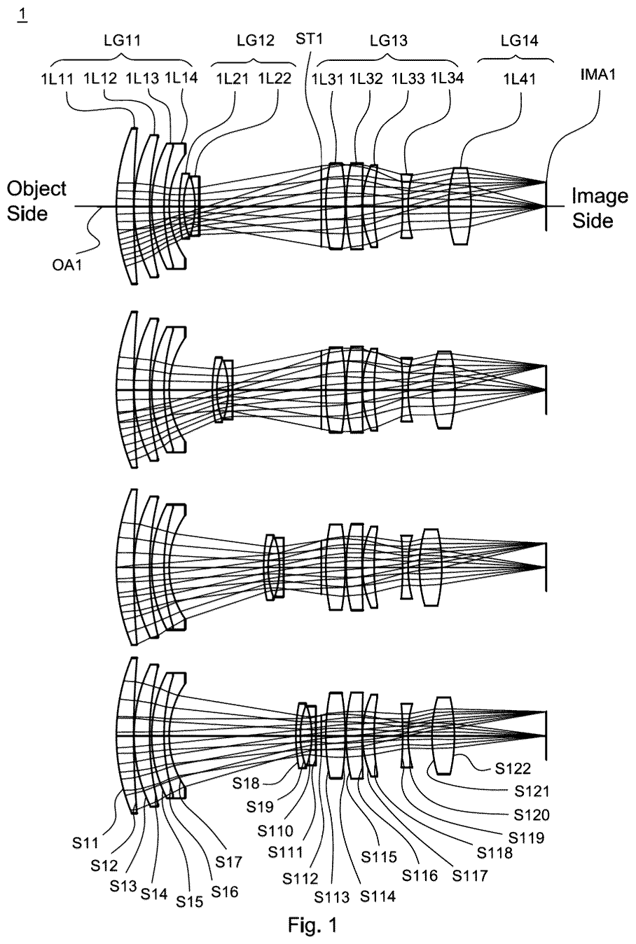

FIGS. 1, 2, 9, 16, and 23 are lens layout and optical path diagrams of the lens assemblies in accordance with the first, second, third, fourth, and fifth embodiments of the invention, respectively, wherein each figure from top to bottom represents the lens assembly at a wide-angle end, a first middle end, a second middle end, and a telephoto end, respectively.

The 1-1 lenses 1L11, 2L11, 3L11, 4L11, 5L11 are meniscus lenses with positive refractive power, made of glass material, and closest to the object side, wherein the object side surfaces S11, S21, S31, S41, S51 are convex surfaces, the image side surfaces S12, S22, S32, S42, S52 are concave surfaces, and both of the surfaces are spherical surfaces. The 1-2 lenses 1L12, 2L12, 3L12, 4L12, 5L12 are meniscus lenses with positive refractive power and made of plastic material, wherein the object side surfaces S13, S23, S33, S43, S53 are convex surfaces, the image side surfaces S14, S24, S34, S44, S54 are concave surfaces, both of the surfaces are aspherical surfaces, and the 1-2 lenses 1L12, 2L12, 3L12, 4L12, 5L12 are adjacent to the 1-1 lenses 1L11, 2L11, 3L11, 4L11, 5L11 with an air gap, respectively. The 1-3 lenses 1L13, 2L13, 3L13, 4L13, 5L13 are meniscus lenses with positive refractive power and made of glass material, wherein the object side surfaces S15, S25, S35, S45, S55 are convex surfaces, the image side surfaces S16, S26, S36, S46, S56 are concave surfaces, both of the surfaces are spherical surfaces, and the 1-3 lenses 1L13, 2L13, 3L13, 4L13, 5L13 are adjacent to the 1-2 lenses 1L12, 2L12, 3L12, 4L12, 5L12 with an air gap, respectively, which helps to correct lateral color. The 1-4 lenses 1L14, 2L14, 3L14, 4L14, 5L14 are meniscus lenses with negative refractive power and made of glass material, wherein the object side surfaces S16, S26, S36, S46, S56 are convex surfaces, the image side surfaces S17, S27, S37, S47, S57 are concave surfaces, both of the surfaces are spherical surfaces, which helps to correct lateral color. The 1-3 lenses 1L13, 2L13, 3L13, 4L13, 5L13 and the 1-4 lenses 1L14, 2L14, 3L14, 4L14, 5L14 are cemented or there is no air gap between them, which helps to correct lateral color.

The 2-1 lenses 1L21, 2L21, 3L21, 4L21, 5L21 are meniscus lenses with negative refractive power and made of plastic material, wherein the object side surfaces S18, S28, S38, S48, S58 are convex surfaces, the image side surfaces S19, S29, S39, S49, S59 are concave surfaces, and both of the surfaces are aspheric surfaces. The 2-2 lenses 1L22, 2L22, 3L22, 4L22, 5L22 are meniscus lenses or biconcave lenses with negative refractive power and made of glass material, wherein the object side surfaces S110, S212, S312, S412, S510 are concave surfaces and are spherical surfaces, the image side surfaces S111, S213, S313, S413, S511 are spherical surfaces, which helps to increase the zoom ratio.

The 3-1 lenses 1L31, 2L31, 3L31, 4L31, 5L31 are biconvex lenses with positive refractive power and made of glass material, wherein the object side surfaces S113, S215, S315, S415, S512 are convex surfaces, the image side surfaces S114, S216, S316, S416, S513 are convex surfaces, and both of the surfaces are spherical surfaces. The 3-2 lenses 1L32, 2L32, 3L32, 4L32, 5L32 are meniscus lenses with positive refractive power and made of glass material, wherein the object side surfaces S115, S217, S317, S417, S515 are convex surfaces, the image side surfaces S116, S218, S318, S418, S516 are concave surfaces, and both of the surfaces are spherical surfaces. The 3-3 lenses 1L33, 2L33, 3L33, 4L33, 5L33 are meniscus lenses with positive refractive power and made of glass material, wherein the object side surfaces S117, S219, S319, S419, S517 are convex surfaces, the image side surfaces S118, S220, S320, S420, S518 are concave surfaces, and both of the surfaces are spherical surfaces. The 3-4 lenses 1L34, 2L34, 3L34, 4L34, 5L34 are biconcave lenses with negative refractive power and made of glass material, wherein the object side surfaces S119, S221, S321, S421, S521 are concave surfaces, the image side surfaces S120, S222, S322, S422, S522 are concave surfaces, and both of the surfaces spherical surfaces, which helps to shorten the total lens length.

The 4-1 lenses 1L41, 2L41, 3L41, 4L41, 5L41 are biconvex lenses with positive refractive power and made of plastic material, wherein the object side surfaces S121, S223, S323, S423, S523 are convex surfaces, the image side surfaces S122, S224, S324, S424, S524 are convex surfaces, and both of surfaces are aspheric surfaces, which helps to increase the zoom ratio.

In addition, the lens assembly 1 further satisfies at least one of the following conditions (1)-(10):

−92 mm⁻¹≤(rb/dc)/fw≤2 mm⁻¹; (1)

−1.5≤(db−fa)/rb≤0.8; (2)

−7.4≤(ra−rc)/ft≤5.4; (3)

−9.76≤rc/(f3g−fc)≤−0.76; (4)

10≤(ft−fw)/dc≤26 (5)

−7.5 mm≤ft/(f34/dc)≤−2 mm (6)

−15.7≤(rc/fa)−fw≤−1.7 (7)

−104 mm≤(fc/Y)×f4g≤−60 mm (8)

3.8≤ft/fw≤4.9 (9)

−30 mm≤(ra/fb)×dc≤1.5 mm (10)
wherein rb is a radius of curvature of the image side surfaces S111, S213, S313, S413, S513 of the lenses 1L22, 2L22, 3L22, 4L22, 5L31 which are between the object side and the stops ST1, ST2, ST3, ST4, ST5 and closest to the stops ST1, ST2, ST3, ST4, ST5 for the first to fifth embodiments; de is an interval along the optical axes OA1, OA2, OA3, OA4, OA5 from the image side surfaces S118, S220, S320, S420, S520 of the lenses 1L33, 2L33, 3L33, 4L33, 5L35 which are among the third lens groups LG13, LG23, LG33, LG43, LG53 and second closest to the image side to the object side surfaces S119, S221, S321, S421, S521 of the lenses 1L34, 2L34, 3L34, 4L34, 5L34 which are among the third lens group LG13, LG23, LG33, LG43, LG53 and closest to the image side for the first to fifth embodiments; db is an interval from the image side surfaces S122, S224, S324, S424, S524 of the 4-1 lenses 1L41, 2L41, 3L41, 4L41, 5L41 to the image planes IMA1, IMA2, IMA3, IMA4, IMA5 along the optical axes OA1, OA2, OA3, OA4, OA5 when the lens assemblies 1, 2, 3, 4, 5 are at the telephoto end for the first to fifth embodiments; fa is an effective focal length of the 2-1 lenses 1L21, 2L21, 3L21, 4L21, 5L21 for the first to fifth embodiments; ra is a radius of curvature of the image side surfaces S211, S311, S411 of the lenses 2L23, 3L23, 4L23 which are with positive refractive power and among the second lens groups LG22, LG32, LG42 for the second to fourth embodiments; rc is a radius of curvature of the object side surfaces S119, S221, S321, S421, S521 of the lenses 1L34, 2L34, 3L34, 4L34, 5L34 which are closest to the image side and among the third lens group LG13, LG23, LG33, LG43, LG53 for the first to fifth embodiments; ft is an effective focal length of the lens assemblies 1, 2, 3, 4, 5 when the lens assemblies 1, 2, 3, 4, 5 are at the telephoto end for the first to fifth embodiments; f3g is an effective focal length of the third lens groups LG13, LG23, LG33, LG43, LG53 for the first to fifth embodiments; fc is an effective focal length of the lenses 1L22, 2L22, 3L22, 4L22, 5L22 which are closest to the image side and among the second lens groups LG12, LG22, LG32, LG42, LG52 for the first to fifth embodiments; fb is an effective focal length of the lenses 2L23, 3L23, 4L23 which are with positive refractive power and among the second lens groups LG22, LG32, LG42 for the second to fourth embodiments; fw is an effective focal length of the lens assemblies 1, 2, 3, 4, 5 when the lens assemblies 1, 2, 3, 4, 5 are at the wide-angle end for the first to fifth embodiments; f34 is a combined effective focal length of the combinations of the 1-3 lenses 1L13, 2L13, 3L13, 4L13, 5L13 and the 1-4 lenses 1L14, 2L14, 3L14, 4L14, 5L14 for the first to fifth embodiments; Y is a maximum image height of the lens assemblies 1, 2, 3, 4, 5 for the first to fifth embodiments; and f4g is an effective focal length of the fourth lens groups LG14, LG24, Lg34, LG44, LG54 for the first to fifth embodiments. Making the lens assemblies 1, 2, 3, 4, 5 effectively shortening the total lens length, effectively correcting lateral color, effectively increasing the zoom ratio, and effectively correcting aberration.

When the condition (1): −92 mm⁻¹≤(rb/dc)/fw≤2 mm⁻¹ is satisfied, the field curvature can be decreased effectively, the zoom ratio can be increased effectively, and the basic operation can be achieved. When the conditions (2): −1.5≤(db−fa)/rb≤0.8 are satisfied, the lateral color can be decreased effectively and the basic operation can be achieved. When the condition (3): −7.4≤(ra−rc)/ft≤5.4 is satisfied, the aberration and astigmatism in off-axis field of view can be decreased effectively and the basic operation can be achieved. When the condition (4): −9.76≤rc/(f3g−fc)≤−0.76 is satisfied, the spherical aberration can be effectively decreased, the total lens length can be effectively decreased, and the basic operation can be achieved. When the condition (5): 10≤(ft−fw)/dc≤26 is satisfied, the image quality can be increased effectively and the basic operation can be achieved. When the condition (6): −7.5 mm≤ft/(f34/dc)≤−2 mm is satisfied, the image quality can be increased effectively and the basic operation can be achieved. When the condition (7): −15.7≤(rc/fa)−fw≤−1.7 is satisfied, the image quality can be increased effectively and the basic operation can be achieved. When the condition (8): −104 mm≤(fc/Y)×f4g≤−60 mm is satisfied, the image quality can be increased effectively and the basic operation can be achieved. When the condition (9): 3.8≤ft/fw≤4.9 is satisfied, the image quality can be increased effectively and the basic operation can be achieved. When the condition (10): −30 mm≤(ra/fb)×dc≤1.5 mm is satisfied, the distortion can be decreased effectively, the longitudinal chromatic aberration can be decreased effectively, and the basic operation can be achieved.

A detailed description of a lens assembly in accordance with a first embodiment of the invention is as follows. Referring to FIG. 1, the lens assembly 1 includes a first lens group LG11, a second lens group LG12, a stop ST1, a third lens group LG13, and a fourth lens group LG14, all of which are arranged in order from an object side to an image side along an optical axis OA1. The first lens group LG11 is with positive refractive power, the second lens group LG12 is with negative refractive power, the third lens group LG13 is with positive refractive power, and the fourth lens group LG14 is with positive refractive power. The first lens group LG11 includes a 1-1 lens 1L11, a 1-2 lens 1L12, a 1-3 lens 1L13, and a 1-4 lens 1L14, all of which are arranged in order from the object side to the image side along the optical axis OA1. The second lens group LG12 includes a 2-1 lens 1L21 and a 2-2 lens 1L22, both of which are arranged in order from the object side to the image side along the optical axis OA1. The third lens group LG13 includes a 3-1 lens 1L31, a 3-2 lens 1L32, a 3-3 lens 1L33, and a 3-4 lens 1L34, all of which are arranged in order from the object side to the image side along the optical axis OA1. The fourth lens group LG14 includes a 4-1 lens 1L41. The first lens group LG11 is fixed, the second lens group LG12 moves from the object side to the image side along the optical axis OA1, the third lens group LG13 is fixed, and the fourth lens group LG14 moves to the image side or object side along the optical axis OA1, when zooming from a wide-angle end to a telephoto end. In operation, the light from the object side is imaged on an image plane IMA1. According to the foregoing, wherein: the 2-2 lens 1L22 is a meniscus lens, wherein the image side surface S111 is a convex surface; with the above design of the lenses, and at least one of the conditions (1)-(10) are satisfied, the lens assembly 1 can have an effective decreased total lens length, an effective corrected lateral color, an effective increased zoom ratio, and an effective corrected aberration.

Table 1 shows the optical specification of the lens assembly 1 in FIG. 1.

TABLE 1
Effective Focal Length = 16.35 mm-71.89 mm F-number = 2.25-4.55
Total Lens Length = 69.9867 mm Full Field of View = 4.995 degrees-23.89 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S11 | 26.27 | 2.75 | 1.75 | 52.00 | 47.13 | 1L11 |
| S12 | 101.97 | 0.12 | | | | |
| S13 | 20.80 | 2.56 | 1.54 | 56.00 | 74.68 | 1L12 |
| S14 | 41.71 | 0.14 | | | | |
| S15 | 16.44 | 2.23 | 1.50 | 70.00 | 22.30 | 1L13 |
| S16 | 25.53 | 0.82 | 1.92 | 20.00 | −18.09 | 1L14 |
| S17 | 12.49 | 1.69 (Wide-angle End) | | | −45.90 | |
| | | 7.17 (The First Middle End) | | | | |
| | | 15.39 (The Second Middle End) | | | | |
| | | 20.73 (Telephoto End) | | | | |
| S18 | 24.39 | 0.54 | 1.54 | 56.00 | −31.30 | 1L21 |
| S19 | 9.83 | 2.01 | | | | |
| S110 | −11.36 | 0.59 | 1.60 | 61.00 | −19.20 | 1L22 |
| S111 | −6587.27 | 19.99 (Wide-angle End) | | | | |
| | | 14.51 (The First Middle End) | | | | |
| | | 6.29 (The Second Middle End) | | | | |
| | | 0.95 (Telephoto End) | | | | |
| S112 | ∞ | 0.80 | | | | ST1 |
| S113 | 30.01 | 3.03 | 1.52 | 64.00 | 31.83 | 1L31 |
| S114 | −34.70 | 0.10 | | | | |
| S115 | 21.18 | 2.61 | 1.76 | 52.00 | 33.38 | 1L32 |
| S116 | 130.95 | 0.17 | | | | |
| S117 | 13.41 | 1.80 | 1.52 | 64.00 | 49.12 | 1L33 |
| S118 | 27.33 | 4.77 | | | | |
| S119 | −40.49 | 0.78 | 1.92 | 19.00 | −11.78 | 1L34 |
| S120 | 14.23 | 6.61 (Wide-angle End) | | | | |
| | | 3.99 (The First Middle End) | | | | |
| | | 1.93 (The Second Middle End) | | | | |
| | | 3.81 (Telephoto End) | | | | |
| S121 | 15.09 | 3.67 | 1.54 | 56.00 | 16.68 | 1L41 |
| S122 | −19.80 | 12.20 (Wide-angle End) | | | | |
| | | 14.82 (The First Middle End) | | | | |
| | | 16.89 (The Second Middle End) | | | | |
| | | 15.00 (Telephoto End) | | | | |

The aspheric surface sag z of each aspheric lens in table 1 can be calculated by the following formula:

z=ch²/{1+[1−(k+1)c²h²]^{1/2}}+Ah⁴+Bh⁶+Ch⁸
where c is curvature, h is the vertical distance from the lens surface to the optical axis, k is conic constant and A, B, and C are aspheric coefficients. In the first embodiment, the conic constant k and the aspheric coefficients A, B, C of each aspheric lens are shown in Table 2.

TABLE 2

| Surface | | | | |
|---|---|---|---|---|
| Number | k | A | B | C |
| S13 | 0 | 1.83E−06 | 4.47E−08 | −1.26E−10 |
| S14 | 0 | 6.82E−06 | 4.89E−08 | −2.19E−10 |
| S18 | 0 | −4.82E−04 | 2.26E−05 | −1.73E−07 |
| S19 | 0 | −6.02E−04 | 2.18E−05 | 4.25E−08 |
| S121 | 0 | −7.25E−05 | −1.30E−08 | 5.08E−08 |
| S122 | 0 | 7.10E−05 | −5.49E−07 | 6.42E−08 |

Table 3 shows the parameters and condition values for conditions (1), (2), (4)-(9) in accordance with the first embodiment of the invention. By satisfying the conditions (1), (2), (4)-(9), and the refractive power and surface shape in Table 1, which making the first embodiment is a preferred embodiment of the present invention.

TABLE 3

| | | | | | | | |
|---|---|---|---|---|---|---|---|
| rb | −6587.27 | mm | dc | 4.77 | mm | db | 15.00 mm |
| fa | −31.30 | mm | rc | −40.49 | mm | ft | 71.54 mm |
| f3g | 19.90 | mm | fc | −19.20 | mm | fw | 16.50 mm |
| f34 | −45.90 | mm | Y | 3.4 | mm | f4g | 16.68 mm |

| | | | | | | |
|---|---|---|---|---|---|---|
| (rb/dc)/fw | −83.7 | mm⁻¹ | (db − fa)/rb | −0.01 | rc/(f3g − fc) | −1.04 |

| | | | | | | |
|---|---|---|---|---|---|---|
| (ft − fw)/dc | 11.54 | ft/(f34/dc) | −7.43 | mm | (rc/fa) − fw | −15.2 |

| | | | | |
|---|---|---|---|---|
| (fc/Y) × f4g | −94.2 | mm | ft/fw | 4.34 |

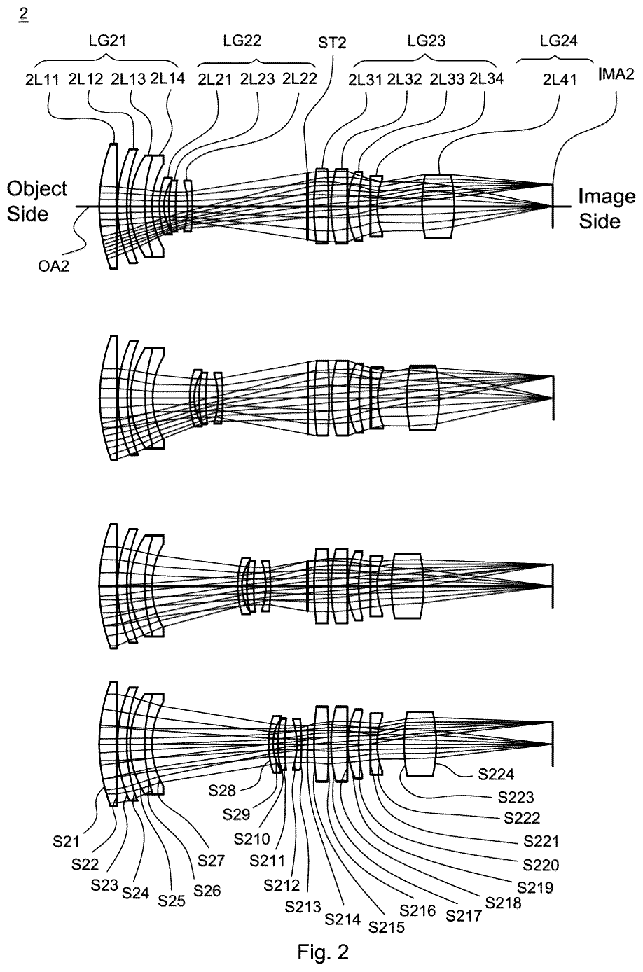

A detailed description of a lens assembly in accordance with a second embodiment of the invention is as follows. Referring to FIG. 2, the lens assembly 2 includes a first lens group LG21, a second lens group LG22, a stop ST2, a third lens group LG23, and a fourth lens group LG24, all of which are arranged in order from an object side to an image side along an optical axis OA2. The first lens group LG21 is with positive refractive power, the second lens group LG22 is with negative refractive power, the third lens group LG23 is with positive refractive power, and the fourth lens group LG24 is with positive refractive power. The first lens group LG21 includes a 1-1 lens 2L11, a 1-2 lens 2L12, a 1-3 lens 2L13, and a 1-4 lens 2L14, all of which are arranged in order from the object side to the image side along the optical axis OA2. The second lens group LG22 includes a 2-1 lens 2L21, a 2-3 lens 2L23, and a 2-2 lens 2L22, all of which are arranged in order from the object side to the image side along the optical axis OA2. The third lens group LG23 includes a 3-1 lens 2L31, a 3-2 lens 2L32, a 3-3 lens 2L33, and a 3-4 lens 2L34, all of which are arranged in order from the object side to the image side along the optical axis OA2. The fourth lens group LG24 includes a 4-1 lens 2L41. The first lens group LG21 is fixed, the second lens group LG22 moves from the object side to the image side along the optical axis OA2, the third lens group LG23 is fixed, and the fourth lens group LG24 moves to the image side or object side along the optical axis OA2, when zooming from a wide-angle end to a telephoto end. In operation, the light from the object side is imaged on an image plane IMA2. According to the foregoing, wherein: the 2-3 lens 2L23 is a meniscus lens with positive refractive power and made of glass material, wherein the object side surface S210 is a convex surface, the image side surface S211 is a concave surface, and both of the object side surface S210 and image side surface S211 are aspheric surfaces; the 2-2 lens 2L22 is a meniscus lens, wherein the image side surface S213 is a convex surface; with the above design of the lenses, stop ST2, and at least one of the conditions (1)-(10) are satisfied, the lens assembly 2 can have an effective decreased total lens length, an effective corrected lateral color, an effective increased zoom ratio, and an effective corrected aberration.

Table 4 shows the optical specification of the lens assembly 2 in FIG. 2.

TABLE 4
Effective Focal Length = 16.43 mm-71.813 mm F-number = 2.35-4.57
Total Lens Length = 71.085 mm Full Field of View = 5.036 degrees-23.494 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S21 | 30.01 | 2.26 | 1.76 | 52.00 | 51.31 | 2L11 |
| S22 | 132.48 | 0.14 | | | | |
| S23 | 19.96 | 2.06 | 1.54 | 56.00 | 87.12 | 2L12 |
| S24 | 33.76 | 0.10 | | | | |
| S25 | 14.20 | 2.34 | 1.50 | 70.00 | 19.09 | 2L13 |
| S26 | 21.32 | 1.07 | 1.92 | 21.00 | −18.16 | 2L14 |
| S27 | 11.97 | 1.46 (Wide-angle End) | | | −63.44 | |
| | | 6.26 (The First Middle End) | | | | |
| | | 13.63 (The Second Middle End) | | | | |
| | | 18.72 (Telephoto End) | | | | |
| S28 | 15.79 | 0.59 | 1.54 | 56.00 | −23.88 | 2L21 |
| S29 | 6.96 | 0.88 | | | | |
| S210 | 12.36 | 0.81 | 1.65 | 21.00 | 75.00 | 2L23 |
| S211 | 16.33 | 2.25 | | | | |
| S212 | −9.22 | 0.55 | 1.83 | 43.00 | −16.33 | 2L22 |
| S213 | −30.65 | 18.20 (Wide-angle End) | | | | |
| | | 13.40 (The First Middle End) | | | | |
| | | 6.04 (The Second Middle End) | | | | |
| | | 0.94 (Telephoto End) | | | | |
| S214 | ∞ | 0.80 | | | | ST2 |
| S215 | 30.00 | 2.56 | 1.52 | 64.00 | 33.68 | 2L31 |
| S216 | −39.70 | 0.10 | | | | |
| S217 | 17.99 | 2.57 | 1.73 | 55.00 | 27.62 | 2L32 |
| S218 | 176.99 | 0.10 | | | | |
| S219 | 11.68 | 1.64 | 1.52 | 64.00 | 46.75 | 2L33 |
| S220 | 21.65 | 2.19 | | | | |
| S221 | −350.74 | 0.80 | 1.90 | 21.00 | −12.58 | 2L34 |
| S222 | 11.33 | 7.06 (Wide-angle End) | | | | |
| | | 4.47 (The First Middle End) | | | | |
| | | 2.19 (The Second Middle End) | | | | |
| | | 4.31 (Telephoto End) | | | | |
| S223 | 16.50 | 5.20 | 1.54 | 56.00 | 19.08 | 2L41 |
| S224 | −23.57 | 15.36 (Wide-angle End) | | | | |
| | | 17.95 (The First Middle End) | | | | |
| | | 20.23 (The Second Middle End) | | | | |
| | | 18.10 (Telephoto End) | | | | |

The definition of aspheric surface sag z of each aspheric surface in Table 4 is the same as that of in Table 1, and is not described here again. In the second embodiment, the conic constant k and the aspheric coefficients A, B, C of each aspheric lens are shown in Table 5.

TABLE 5

| Surface | | | | |
|---|---|---|---|---|
| Number | k | A | B | C |
| S23 | 0 | 1.42E−05 | 4.46E−08 | 2.40E−10 |
| S24 | 0 | 2.07E−05 | 2.92E−08 | 4.12E−11 |
| S28 | 0 | −4.21E−04 | 2.53E−05 | −2.24E−07 |
| S29 | 0 | −7.25E−04 | 2.54E−05 | −5.04E−08 |
| S210 | 0 | 0.00E+00 | 0.00E+00 | 0.00E+00 |
| S211 | 0 | 0.00E+00 | 0.00E+00 | 0.00E+00 |
| S223 | 0 | −7.11E−05 | 3.71E−07 | 2.86E−08 |
| S224 | 0 | 3.65E−05 | −4.97E−07 | 4.47E−08 |

Table 6 shows the parameters and condition values for conditions (1)-(10) in accordance with the second embodiment of the invention. It can be seen from Table 6 that the lens assembly 2 of the second embodiment satisfies the conditions (1)-(10). By satisfying the conditions (1)-(10), and the refractive power and surface shape in Table 4, which making the second embodiment is a preferred embodiment of the present invention.

TABLE 6

| | | | | | | | |
|---|---|---|---|---|---|---|---|
| rb | −30.65 | mm | dc | 2.19 | mm | db | 18.1 mm |
| fa | −23.88 | mm | rc | −350.74 | mm | ft | 71.81 mm |
| f3g | 23.21 | mm | fc | −16.33 | mm | fw | 16.43 mm |
| f34 | −63.44 | mm | Y | 3.4 | mm | f4g | 19.08 mm |
| ra | 16.33 | mm | fb | 75 | mm | | |

| | | | | | | |
|---|---|---|---|---|---|---|
| (rb/dc)/fw | −0.85 | mm⁻¹ | (db − fa)/rb | −1.37 | rc/(f3g − fc) | −8.87 |

| | | | | | | |
|---|---|---|---|---|---|---|
| (ft − fw)/dc | 25.3 | ft/(f34/dc) | −2.48 | mm | (rc/fa) − fw | −1.74 |

| | | | | | | |
|---|---|---|---|---|---|---|
| (fc/Y) × f4g | −91.64 | mm | ft/fw | 4.37 | (ra/fb) × dc | 0.48 mm |

| | |
|---|---|
| (ra − rc)/ft | 5.11 |

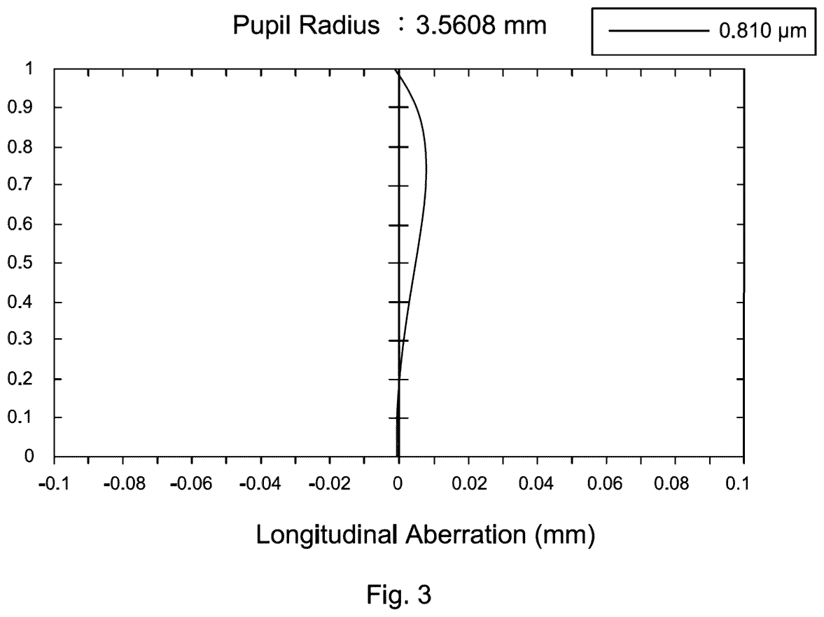

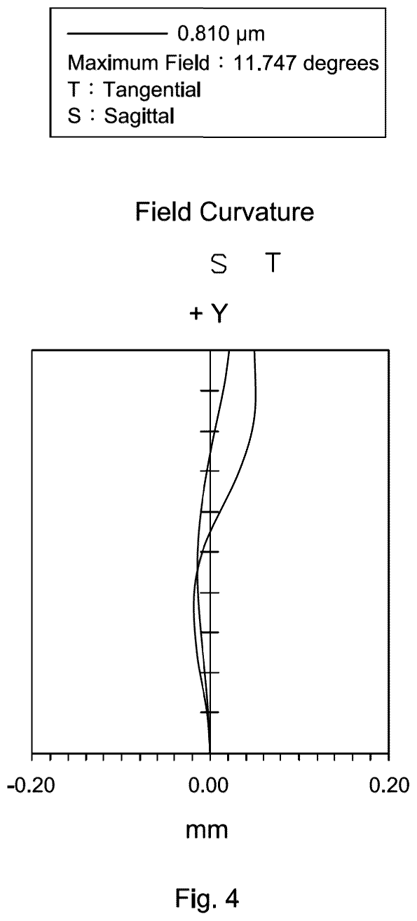

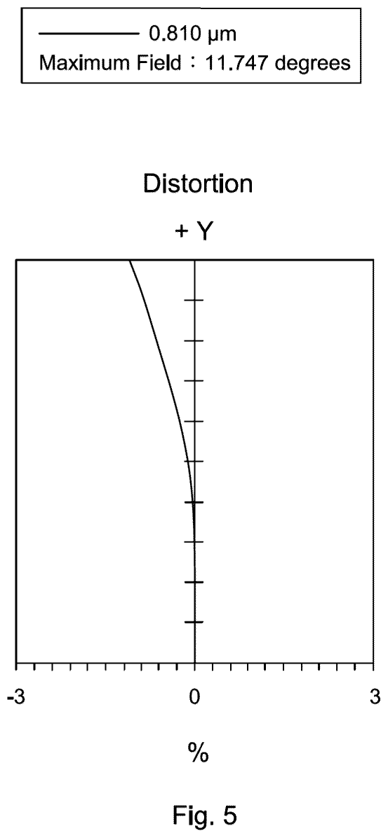

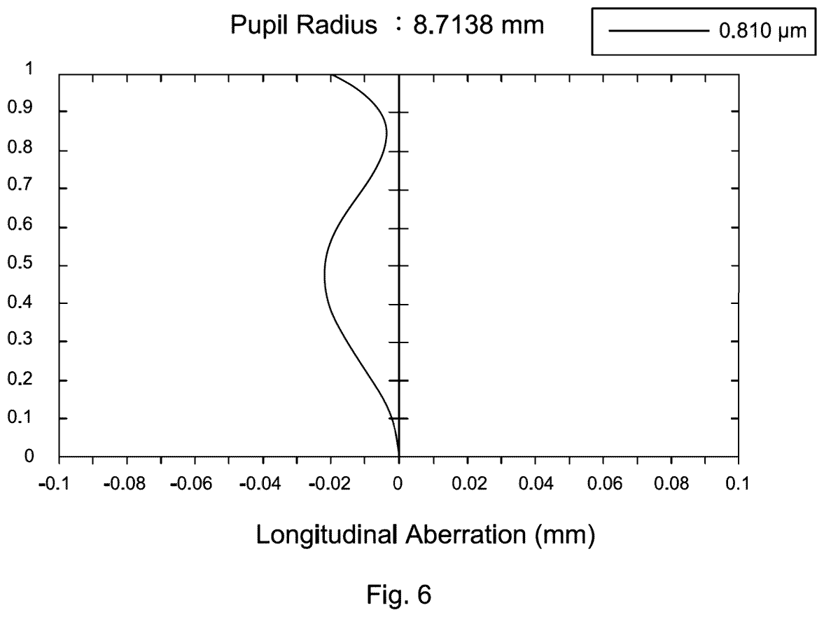

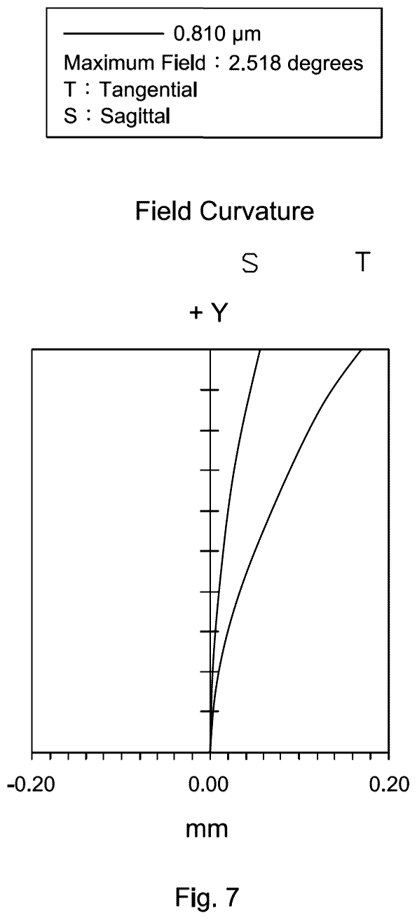

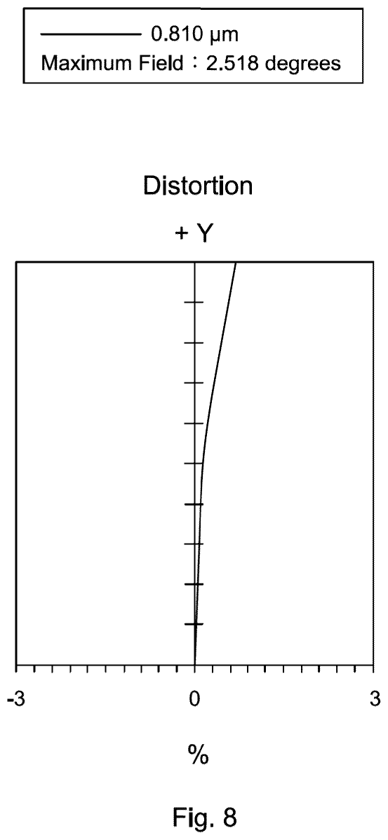

In addition, the lens assembly 2 of the second embodiment can meet the requirements of optical performance as seen in FIGS. 3-8. It can be seen from FIG. 3 that the longitudinal aberration in the lens assembly 2 of the second embodiment at the wide-angle end ranges from −0.01 mm to 0.01 mm. It can be seen from FIG. 4 that the field curvature of tangential direction and sagittal direction in the lens assembly 2 of the second embodiment at the wide-angle end ranges from −0.02 mm to 0.06 mm. It can be seen from FIG. 5 that the distortion in the lens assembly 2 of the second embodiment at the wide-angle end ranges from −1.2% to 0%. It can be seen from FIG. 6 that the longitudinal aberration in the lens assembly 2 of the second embodiment at the telephoto end ranges from −0.03 mm to 0.0 mm. It can be seen from FIG. 7 that the field curvature of tangential direction and sagittal direction in the lens assembly 2 of the second embodiment at the telephoto end ranges from 0.0 mm to 0.17 mm. It can be seen from FIG. 8 that the distortion in the lens assembly 2 of the second embodiment at the telephoto end ranges from 0.0% to 0.7%. It is obvious that the longitudinal aberration, the field curvature and the distortion of the lens assembly 2 of the second embodiment can be corrected effectively. Therefore, the lens assembly 2 of the second embodiment is capable of good optical performance.

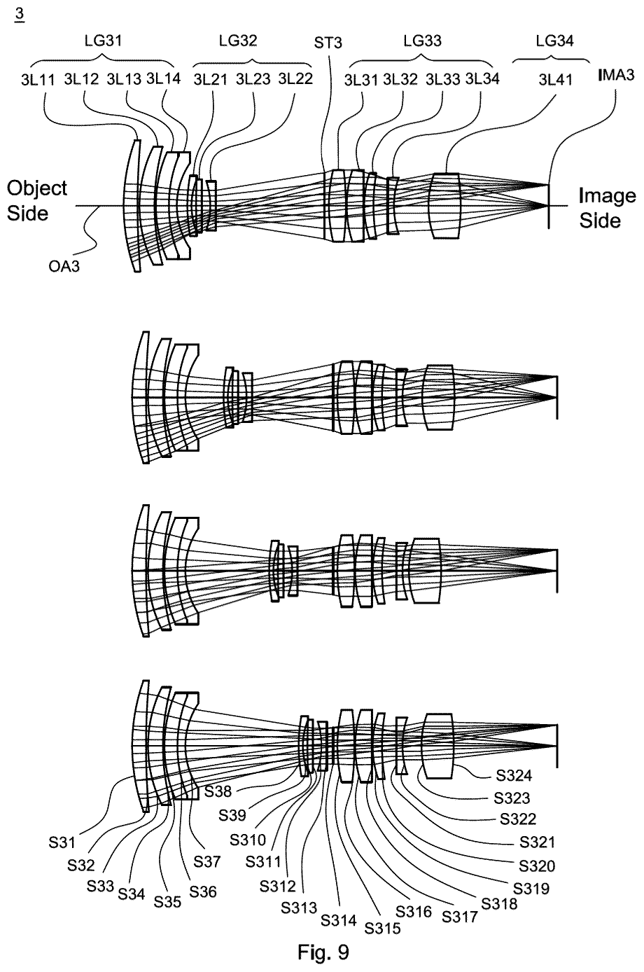

A detailed description of a lens assembly in accordance with a third embodiment of the invention is as follows. Referring to FIG. 9, the lens assembly 3 includes a first lens group LG31, a second lens group LG32, a stop ST3, a third lens group LG33, and a fourth lens group LG34, all of which are arranged in order from an object side to an image side along an optical axis OA3. The first lens group LG31 is with positive refractive power, the second lens group LG32 is with negative refractive power, the third lens group LG33 is with positive refractive power, and the fourth lens group LG34 is with positive refractive power. The first lens group LG31 includes a 1-1 lens 3L11, a 1-2 lens 3L12, a 1-3 lens 3L13, and a 1-4 lens 3L14, all of which are arranged in order from the object side to the image side along the optical axis OA3. The second lens group LG32 includes a 2-1 lens 3L21, a 2-3 lens 3L23, and a 2-2 lens 3L22, all of which are arranged in order from the object side to the image side along the optical axis OA3. The third lens group LG33 includes a 3-1 lens 3L31, a 3-2 lens 3L32, a 3-3 lens 3L33, and a 3-4 lens 3L34, all of which are arranged in order from the object side to the image side along the optical axis OA3. The fourth lens group LG34 includes a 4-1 lens 3L41. The first lens group LG31 is fixed, the second lens group LG32 moves from the object side to the image side along the optical axis OA3, the third lens group LG33 is fixed, and the fourth lens group LG34 moves to the image side or object side along the optical axis OA3, when zooming from a wide-angle end to a telephoto end. In operation, the light from the object side is imaged on an image plane IMA3. According to the foregoing, wherein: the 2-3 lens 3L23 is a biconvex lens with positive refractive power and made of glass material, wherein the object side surface S310 is a convex surface, the image side surface S311 is a convex surface, and both of the object side surface S310 and image side surface S311 are aspheric surfaces; the 2-2 lens 3L22 is a biconcave lens, wherein the image side surface S313 is a concave surface; with the above design of the lenses, stop ST3, and at least one of the conditions (1)-(10) are satisfied, the lens assembly 3 can have an effective decreased total lens length, an effective corrected lateral color, an effective increased zoom ratio, and an effective corrected aberration.

Table 7 shows the optical specification of the lens assembly 3 in FIG. 9.

TABLE 7
Effective Focal Length = 16.35 mm-71.89 mm F-number = 2.20-4.32
Total Lens Length = 70.006 mm Full Field of View = 4.792 degrees-23.978 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S31 | 30.49 | 2.28 | 1.76 | 52.00 | 51.02 | 3L11 |
| S32 | 145.81 | 0.14 | | | | |
| S33 | 17.73 | 2.54 | 1.54 | 56.00 | 72.12 | 3L12 |
| S34 | 31.27 | 0.14 | | | | |
| S35 | 17.84 | 2.39 | 1.50 | 70.00 | 20.76 | 3L13 |
| S36 | 18.52 | 1.30 | 1.92 | 21.00 | −19.31 | 3L14 |
| S37 | 11.99 | 1.27 (Wide-angle End) | | | −49.12 | |
| | | 6.47 (The First Middle End) | | | | |
| | | 13.67 (The Second Middle End) | | | | |
| | | 18.79 (Telephoto End) | | | | |
| S38 | 22.54 | 0.60 | 1.54 | 56.00 | −37.13 | 3L21 |
| S39 | 10.02 | 0.91 | | | | |
| S310 | 32.81 | 0.91 | 1.66 | 21.00 | 48.74 | 3L23 |
| S311 | −603.85 | 1.64 | | | | |
| S312 | −10.61 | 0.55 | 1.83 | 43.00 | −11.35 | 3L22 |
| S313 | 74.81 | 18.06 (Wide-angle End) | | | | |
| | | 13.31 (The First Middle End) | | | | |
| | | 6.11 (The Second Middle End) | | | | |
| | | 0.99 (Telephoto End) | | | | |
| S314 | ∞ | 0.80 | | | | ST3 |
| S315 | 30.00 | 2.79 | 1.52 | 64.00 | 32.40 | 3L31 |
| S316 | −36.23 | 0.10 | | | | |
| S317 | 18.85 | 2.56 | 1.73 | 55.00 | 30.00 | 3L32 |
| S318 | 139.18 | 0.10 | | | | |
| S319 | 12.74 | 1.62 | 1.52 | 64.00 | 52.12 | 3L33 |
| S320 | 23.24 | 2.41 | | | | |
| S321 | −74.46 | 0.84 | 1.76 | 26.00 | −13.86 | 3L34 |
| S322 | 11.96 | 5.90 (Wide-angle End) | | | | |
| | | 3.47 (The First Middle End) | | | | |
| | | 1.26 (The Second Middle End) | | | | |
| | | 3.13 (Telephoto End) | | | | |
| S323 | 14.10 | 5.21 | 1.54 | 56.00 | 18.11 | 3L41 |
| S324 | −26.65 | 14.49 (Wide-angle End) | | | | |
| | | 16.93 (The First Middle End) | | | | |
| | | 19.13 (The Second Middle End) | | | | |
| | | 17.26 (Telephoto End) | | | | |

The definition of aspheric surface sag z of each aspheric surface in Table 7 is the same as that of in Table 1, and is not described here again. In the third embodiment, the conic constant k and the aspheric coefficients A, B, C of each aspheric lens are shown in Table 8.

TABLE 8

| Surface | | | | |
|---|---|---|---|---|
| Number | k | A | B | C |
| S33 | 0 | 3.78E−06 | 2.59E−08 | −5.51E−11 |
| S34 | 0 | 8.54E−06 | 1.79E−08 | −1.15E−10 |
| S38 | 0 | −3.30E−04 | 1.88E−05 | −2.73E−08 |
| S39 | 0 | −5.39E−04 | 1.66E−05 | 2.18E−07 |
| S310 | 0 | 0.00E+00 | 0.00E+00 | 0.00E+00 |
| S311 | 0 | 0.00E+00 | 0.00E+00 | 0.00E+00 |
| S323 | 0 | −2.77E−05 | 1.01E−06 | 3.51E−08 |
| S324 | 0 | 1.00E−04 | 3.00E−07 | 6.73E−08 |

Table 9 shows the parameters and condition values for conditions (1)-(10) in accordance with the third embodiment of the invention. It can be seen from Table 9 that the lens assembly 3 of the third embodiment satisfies the conditions (1)-(10). By satisfying the conditions (1)-(10), and the refractive power and surface shape in Table 7, which making the third embodiment is a preferred embodiment of the present invention.

TABLE 9

| | | | | | | | |
|---|---|---|---|---|---|---|---|
| rb | 74.81 | mm | dc | 2.41 | mm | db | 17.26 mm |
| fa | −37.13 | mm | rc | −74.46 | mm | ft | 71.89 mm |
| f3 g | 23 | mm | fc | −11.35 | mm | fw | 16.35 mm |
| f34 | −49.12 | mm | Y | 3.4 | mm | f4g | 18.11 mm |
| ra | −603.85 | mm | fb | 48.74 | mm | | |

| | | | | | | |
|---|---|---|---|---|---|---|
| (rb/dc)/fw | 1.90 | mm⁻¹ | (db − fa)/rb | 0.73 | rc/(f3g − fc) | −2.17 |

| | | | | | | |
|---|---|---|---|---|---|---|
| (ft − fw)/dc | 23.05 | ft/(f34/dc) | −3.53 | mm | (rc/fa) − fw | −14.34 |

| | | | | | | |
|---|---|---|---|---|---|---|
| (fc/Y) × f4g | −60.46 | mm | ft/fw | 4.40 | (ra/fb) × dc | −29.86 mm |

| | |
|---|---|
| (ra − rc)/ft | −7.36 |

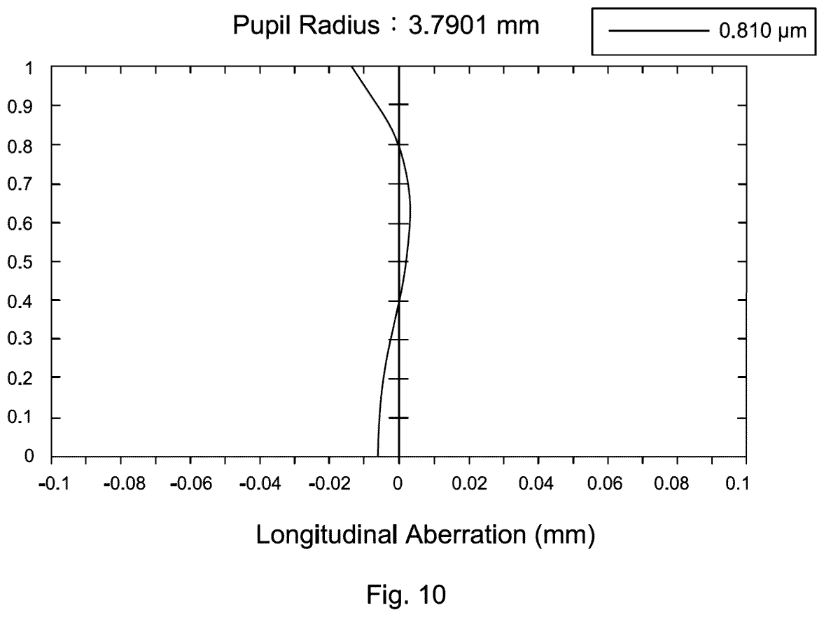

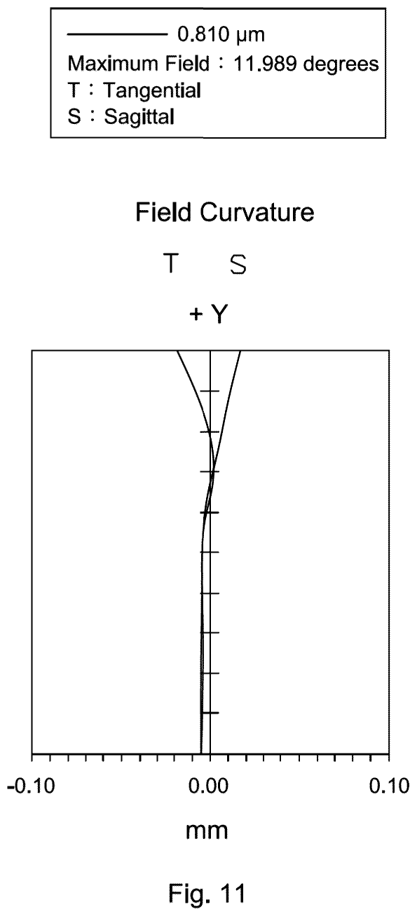

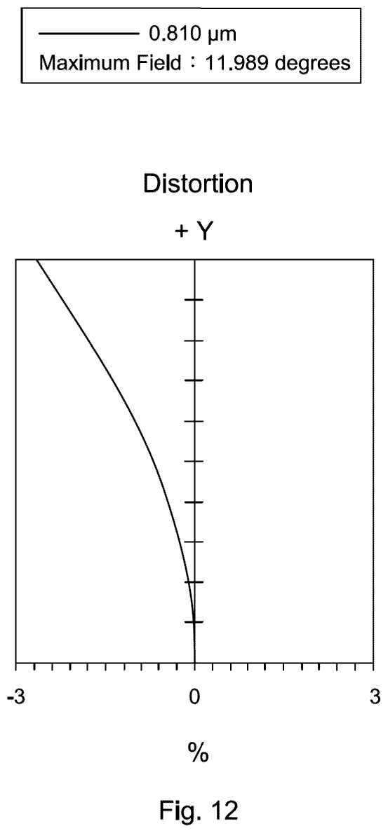

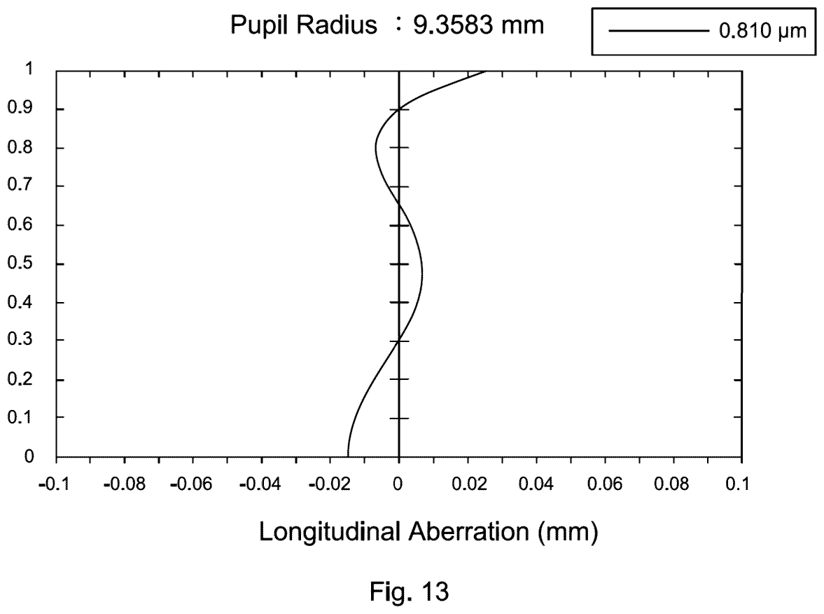

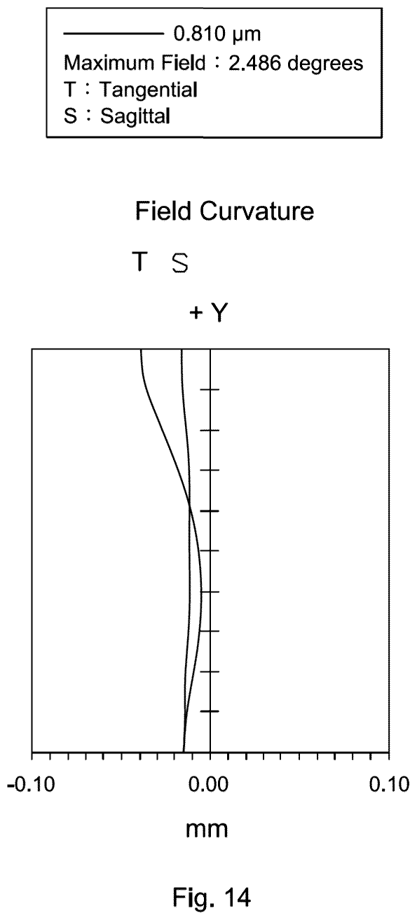

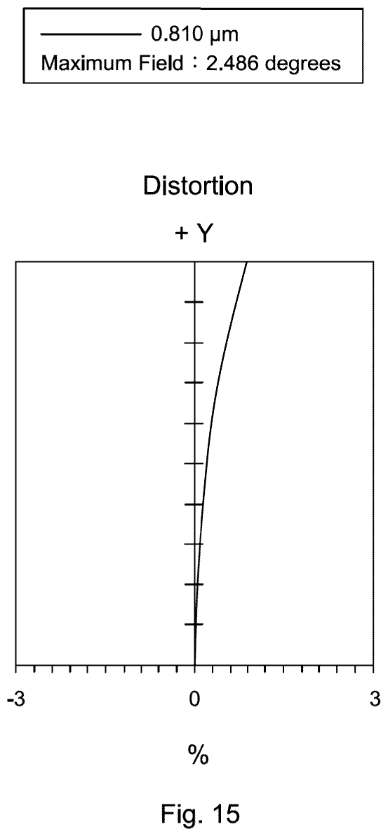

In addition, the lens assembly 3 of the third embodiment can meet the requirements of optical performance as seen in FIGS. 10-15. It can be seen from FIG. 10 that the longitudinal aberration in the lens assembly 3 of the third embodiment at the wide-angle end ranges from −0.02 mm to 0.01 mm. It can be seen from FIG. 11 that the field curvature of tangential direction and sagittal direction in the lens assembly 3 of the third embodiment at the wide-angle end ranges from −0.02 mm to 0.02 mm. It can be seen from FIG. 12 that the distortion in the lens assembly 3 of the third embodiment at the wide-angle end ranges from −2.7% to 0%. It can be seen from FIG. 13 that the longitudinal aberration in the lens assembly 3 of the third embodiment at the telephoto end ranges from −0.02 mm to 0.03 mm. It can be seen from FIG. 14 that the field curvature of tangential direction and sagittal direction in the lens assembly 3 of the third embodiment at the telephoto end ranges from −0.04 mm to 0.0 mm. It can be seen from FIG. 15 that the distortion in the lens assembly 3 of the third embodiment at the telephoto end ranges from 0.0% to 0.9%. It is obvious that the longitudinal aberration, the field curvature and the distortion of the lens assembly 3 of the third embodiment can be corrected effectively. Therefore, the lens assembly 3 of the third embodiment is capable of good optical performance.

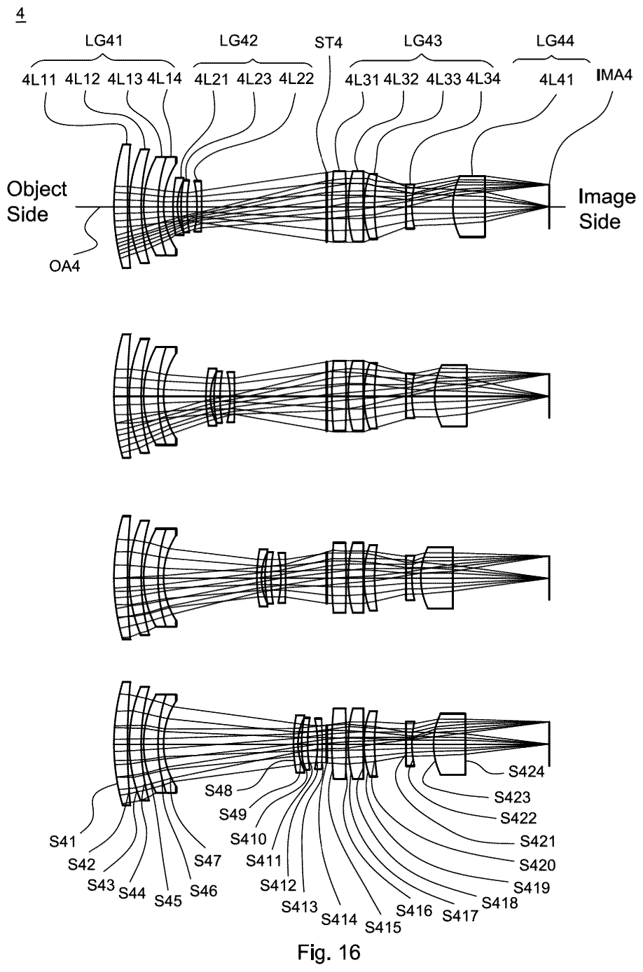

A detailed description of a lens assembly in accordance with a fourth embodiment of the invention is as follows. Referring to FIG. 16, the lens assembly 4 includes a first lens group LG41, a second lens group LG42, a stop ST4, a third lens group LG43, and a fourth lens group LG44, all of which are arranged in order from an object side to an image side along an optical axis OA4. The first lens group LG41 is with positive refractive power, the second lens group LG42 is with negative refractive power, the third lens group LG43 is with positive refractive power, and the fourth lens group LG44 is with positive refractive power. The first lens group LG41 includes a 1-1 lens 4L11, a 1-2 lens 4L12, a 1-3 lens 4L13, and a 1-4 lens 4L14, all of which are arranged in order from the object side to the image side along the optical axis OA4. The second lens group LG42 includes a 2-1 lens 4L21, a 2-3 lens 4L23, and a 2-2 lens 4L22, all of which are arranged in order from the object side to the image side along the optical axis OA4. The third lens group LG43 includes a 3-1 lens 4L31, a 3-2 lens 4L32, a 3-3 lens 4L33, and a 3-4 lens 4L34, all of which are arranged in order from the object side to the image side along the optical axis OA4. The fourth lens group LG44 includes a 4-1 lens 4L41. The first lens group LG41 is fixed, the second lens group LG42 moves from the object side to the image side along the optical axis OA4, the third lens group LG43 is fixed, and the fourth lens group LG44 moves to the image side or object side along the optical axis OA4, when zooming from a wide-angle end to a telephoto end. In operation, the light from the object side is imaged on an image plane IMA4. According to the foregoing, wherein: the 2-3 lens 4L23 is a meniscus lens with positive refractive power and made of glass material, wherein the object side surface S410 is a convex surface, the image side surface S411 is a concave surface, and both of the object side surface S410 and image side surface S411 are aspheric surfaces; the 2-2 lens 4L22 is a meniscus lens, wherein the image side surface S413 is a convex surface; with the above design of the lenses, stop ST4, and at least one of the conditions (1)-(10) are satisfied, the lens assembly 4 can have an effective decreased total lens length, an effective corrected lateral color, an effective increased zoom ratio, and an effective corrected aberration.

Table 10 shows the optical specification of the lens assembly 4 in FIG. 16.

TABLE 10
Effective Focal Length = 16.58 mm-71.89 mm F-number = 2.43-4.7
Total Lens Length = 69.984 mm Full Field of View = 4.942 degrees-23.384 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S41 | 32.30 | 2.21 | 1.75 | 52.00 | 57.73 | 4L11 |
| S42 | 128.94 | 0.16 | | | | |
| S43 | 20.19 | 2.14 | 1.54 | 56.00 | 75.74 | 4L12 |
| S44 | 38.93 | 0.15 | | | | |
| S45 | 14.11 | 2.42 | 1.50 | 70.00 | 19.20 | 4L13 |
| S46 | 21.91 | 0.80 | 1.92 | 21.00 | −17.95 | 4L14 |
| S47 | 11.98 | 1.68 (Wide-angle End) | | | −60.86 | |
| | | 7.08 (The First Middle End) | | | | |
| | | 15.17 (The Second Middle End) | | | | |
| | | 20.86 (Telephoto End) | | | | |
| S48 | 21.81 | 0.58 | 1.54 | 56.00 | −24.57 | 4L21 |
| S49 | 8.11 | 0.61 | | | | |
| S410 | 14.41 | 0.79 | 1.66 | 21.00 | 74.83 | 4L23 |
| S411 | 20.18 | 2.07 | | | | |
| S412 | −11.26 | 0.51 | 1.83 | 43.00 | −18.23 | 4L22 |
| S413 | −47.23 | 20.11 (Wide-angle End) | | | | |
| | | 14.71 (The First Middle End) | | | | |
| | | 6.62 (The Second Middle End) | | | | |
| | | 0.93 (Telephoto End) | | | | |
| S414 | ∞ | 0.80 | | | | ST4 |
| S415 | 29.99 | 2.59 | 1.52 | 64.20 | 33.40 | 4L31 |
| S416 | −38.96 | 0.10 | | | | |
| S417 | 18.64 | 2.45 | 1.73 | 55.00 | 30.00 | 4L32 |
| S418 | 128.41 | 0.10 | | | | |
| S419 | 12.12 | 1.59 | 1.52 | 64.00 | 49.34 | 4L33 |
| S420 | 22.21 | 5.31 | | | | |
| S421 | −52.02 | 0.56 | 1.92 | 21.00 | −10.34 | 4L34 |
| S422 | 11.24 | 6.57 (Wide-angle End) | | | | |
| | | 3.97 (The First Middle End) | | | | |
| | | 1.69 (The Second Middle End) | | | | |
| | | 3.59 (Telephoto End) | | | | |
| S423 | 9.76 | 5.27 | 1.54 | 56.00 | 15.58 | 4L41 |
| S424 | −45.21 | 10.42 (Wide-angle End) | | | | |
| | | 13.03 (The First Middle End) | | | | |
| | | 15.31 (The Second Middle End) | | | | |
| | | 13.41 (Telephoto End) | | | | |

The definition of aspheric surface sag z of each aspheric surface in Table 10 is the same as that of in Table 1, and is not described here again. In the fourth embodiment, the conic constant k and the aspheric coefficients A, B, C of each aspheric lens are shown in Table 11.

TABLE 11

| Surface | | | | |
|---|---|---|---|---|
| Number | k | A | B | C |
| S43 | 0 | −1.78E−06 | 1.04E−07 | 1.72E−10 |
| S44 | 0 | −1.88E−06 | 1.64E−07 | −2.95E−10 |
| S48 | 0 | −3.23E−04 | 1.57E−05 | −1.14E−07 |
| S49 | 0 | −4.92E−04 | 1.40E−05 | 4.19E−08 |
| S410 | 0 | 0.00E+00 | 0.00E+00 | 0.00E+00 |
| S411 | 0 | 0.00E+00 | 0.00E+00 | 0.00E+00 |
| S423 | 0 | 1.21E−05 | 1.93E−06 | 5.70E−08 |
| S424 | 0 | 3.21E−04 | 1.78E−06 | 2.07E−07 |

Table 12 shows the parameters and condition values for conditions (1)-(10) in accordance with the fourth embodiment of the invention. It can be seen from Table 12 that the lens assembly 4 of the fourth embodiment satisfies the conditions (1)-(10). By satisfying the conditions (1)-(10), and the refractive power and surface shape in Table 10, which making the fourth embodiment is a preferred embodiment of the present invention.

TABLE 12

| | | | | | | | |
|---|---|---|---|---|---|---|---|
| rb | −47.23 | mm | dc | 5.31 | mm | db | 13.41 mm |
| fa | −24.57 | mm | rc | −52.02 | mm | ft | 71.91 mm |
| f3g | 19.4 | mm | fc | −18.23 | mm | fw | 16.58 mm |
| f34 | −60.86 | mm | Y | 3.4 | mm | f4g | 15.58 mm |
| ra | 20.18 | mm | fb | 74.83 | mm | | |

| | | | | | | |
|---|---|---|---|---|---|---|
| (rb/dc)/fw | −0.54 | mm⁻¹ | (db − fa)/rb | −0.80 | rc/(f3g − fc) | −1.38 |

| | | | | | | |
|---|---|---|---|---|---|---|
| (ft − fw)/dc | 10.42 | ft/(f34/dc) | −6.27 | mm | (rc/fa) − fw | −14.46 |

| | | | | | | |
|---|---|---|---|---|---|---|
| (fc/Y) × f4g | −83.5 | mm | ft/fw | 4.34 | (ra/fb) × dc | 1.43 mm |

| | |
|---|---|
| (ra − rc)/ft | 1 |

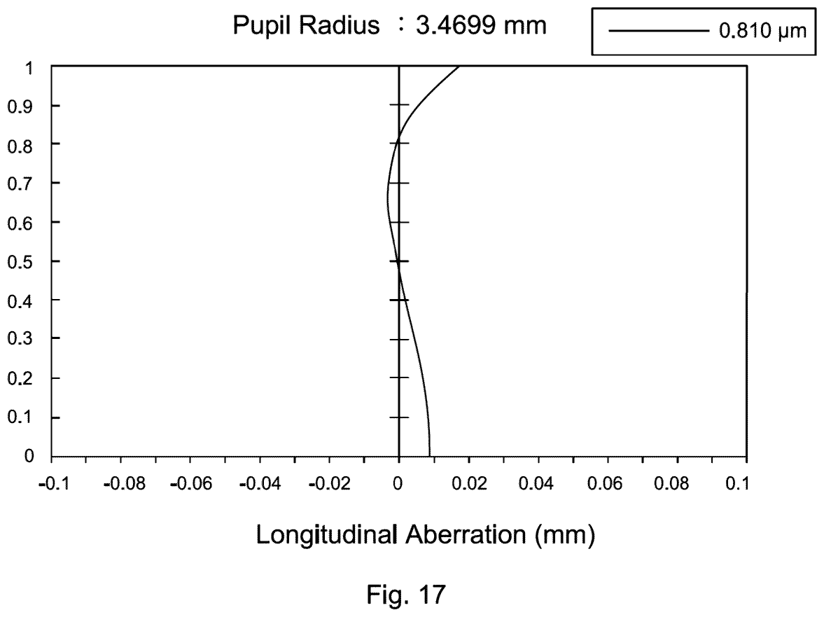

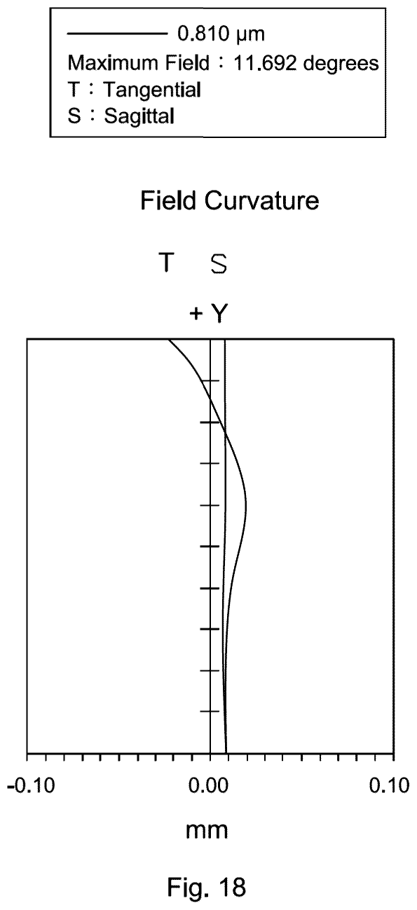

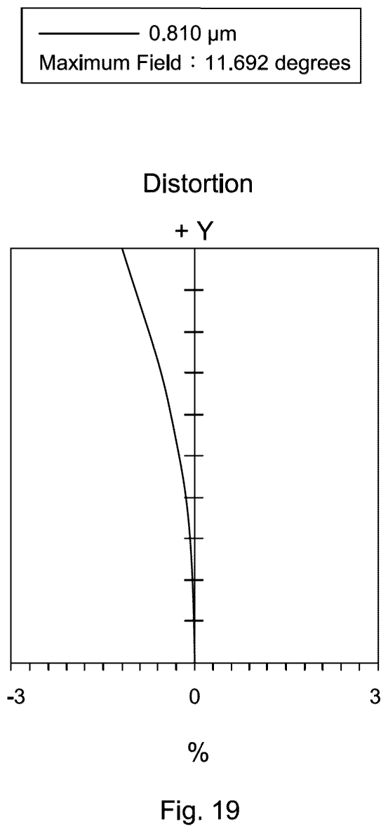

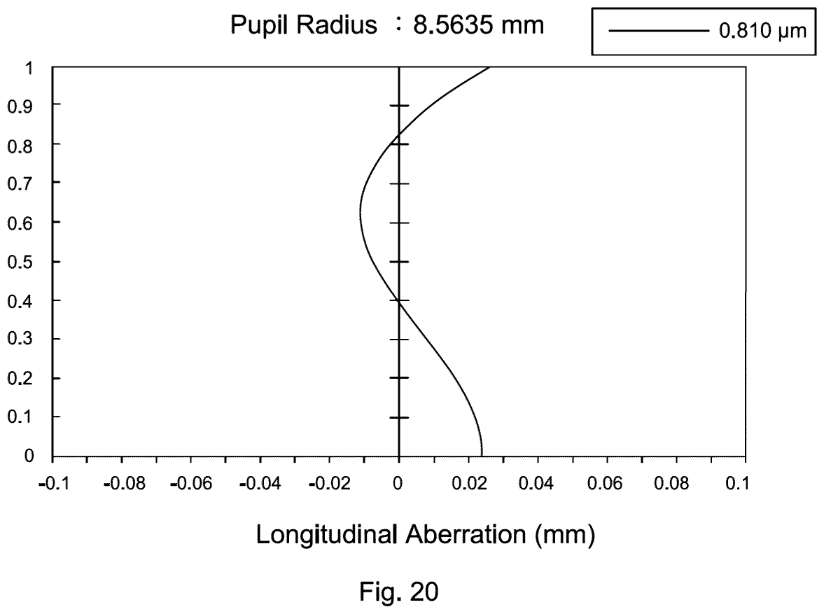

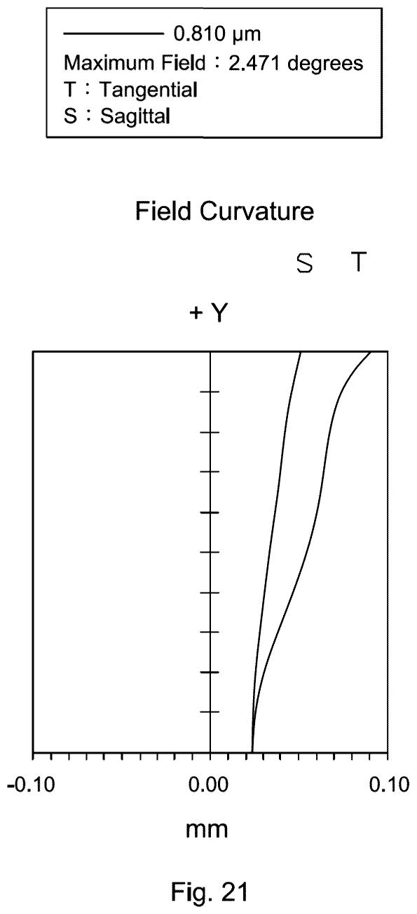

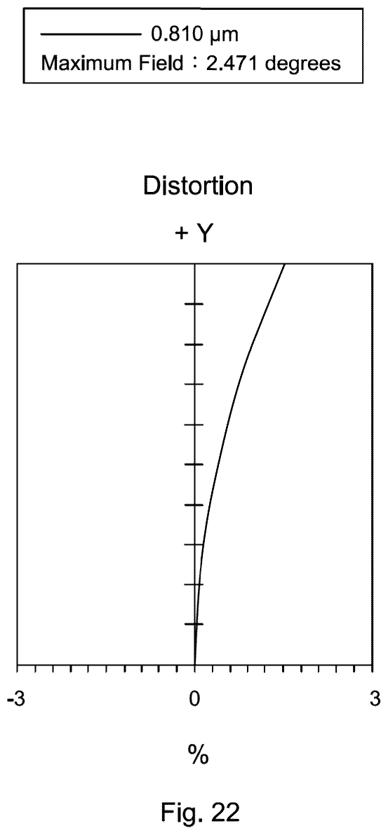

In addition, the lens assembly 4 of the fourth embodiment can meet the requirements of optical performance as seen in FIGS. 17-22. It can be seen from FIG. 17 that the longitudinal aberration in the lens assembly 4 of the fourth embodiment at the wide-angle end ranges from −0.01 mm to 0.02 mm. It can be seen from FIG. 18 that the field curvature of tangential direction and sagittal direction in the lens assembly 4 of the fourth embodiment at the wide-angle end ranges from −0.025 mm to 0.025 mm. It can be seen from FIG. 19 that the distortion in the lens assembly 4 of the fourth embodiment at the wide-angle end ranges from −1.2% to 0%. It can be seen from FIG. 20 that the longitudinal aberration in the lens assembly 4 of the fourth embodiment at the telephoto end ranges from −0.015 mm to 0.025 mm. It can be seen from FIG. 21 that the field curvature of tangential direction and sagittal direction in the lens assembly 4 of the fourth embodiment at the telephoto end ranges from 0.02 mm to 0.09 mm. It can be seen from FIG. 22 that the distortion in the lens assembly 4 of the fourth embodiment at the telephoto end ranges from 0.0% to 1.5%. It is obvious that the longitudinal aberration, the field curvature and the distortion of the lens assembly 4 of the fourth embodiment can be corrected effectively. Therefore, the lens assembly 4 of the fourth embodiment is capable of good optical performance.

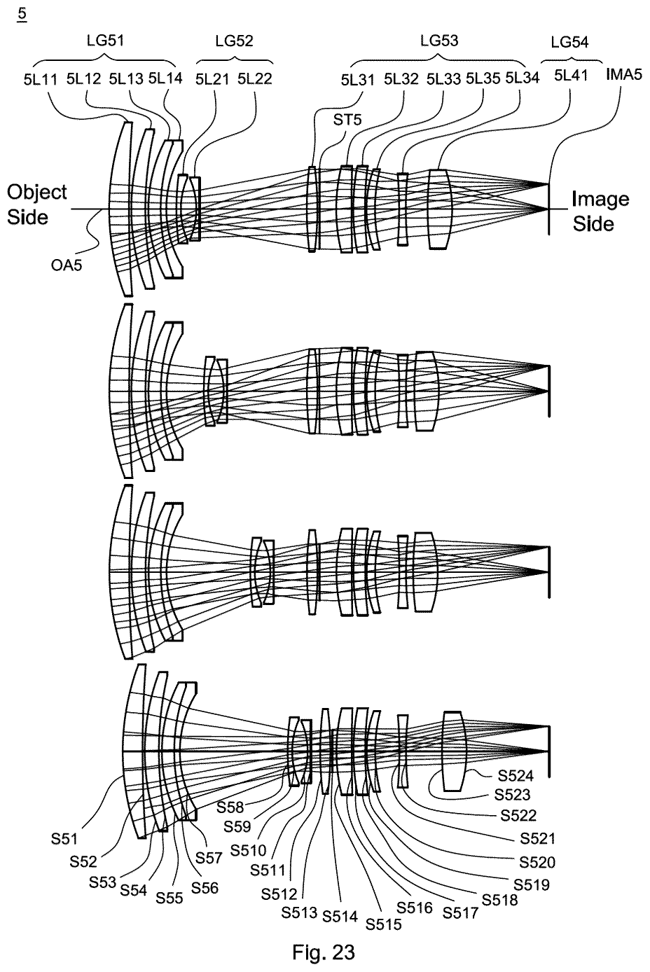

A detailed description of a lens assembly in accordance with a fifth embodiment of the invention is as follows. Referring to FIG. 23, the lens assembly 5 includes a first lens group LG51, a second lens group LG52, a third lens group LG53, and a fourth lens group LG54, all of which are arranged in order from an object side to an image side along an optical axis OA5. The first lens group LG51 is with positive refractive power, the second lens group LG52 is with negative refractive power, the third lens group LG53 is with positive refractive power, and the fourth lens group LG54 is with positive refractive power. The first lens group LG51 includes a 1-1 lens 5L11, a 1-2 lens 5L12, a 1-3 lens 5L13, and a 1-4 lens 5L14, all of which are arranged in order from the object side to the image side along the optical axis OA5. The second lens group LG52 includes a 2-1 lens 5L21 and a 2-2 lens 5L22, all of which are arranged in order from the object side to the image side along the optical axis OA5. The third lens group LG53 includes a 3-1 lens 5L31, a 3-2 lens 5L32, a 3-3 lens 5L33, a 3-5 lens 5L35, and a 3-4 lens 5L34, all of which are arranged in order from the object side to the image side along the optical axis OA5. The fourth lens group LG54 includes a 4-1 lens 5L41. The lens assembly 5 further includes a stop ST5 disposed between the 3-1 lens 5L31 and the 3-2 lens 5L32. The first lens group LG51 is fixed, the second lens group LG52 moves from the object side to the image side along the optical axis OA5, the third lens group LG53 is fixed, and the fourth lens group LG54 moves to the image side or object side along the optical axis OA5, when zooming from a wide-angle end to a telephoto end. In operation, the light from the object side is imaged on an image plane IMA5. According to the foregoing, wherein: the 2-2 lens 5L25 is a meniscus lens, wherein the image side surface S511 is a convex surface; the 3-5 lens 5L35 is a meniscus lens with positive refractive power and made of glass material, wherein the object side surface S519 is a convex surface, the image side surface S520 is a concave surface, and both of the object side surface S519 and image side surface S520 are spherical surfaces; with the above design of the lenses, stop ST5, and at least one of the conditions (1)-(9) are satisfied, the lens assembly 5 can have an effective decreased total lens length, an effective corrected lateral color, an effective increased zoom ratio, and an effective corrected aberration.

Table 13 shows the optical specification of the lens assembly 5 in FIG. 23.

TABLE 13
Effective Focal Length = 16.73 mm-71.17 mm F-number = 2.35-4.26
Total Lens Length = 70 mm Full Field of View = 5.12 degrees-22.9 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S51 | 28.04 | 3.25 | 1.76 | 52.00 | 44.65 | 5L11 |
| S52 | 164.72 | 0.19 | | | | |
| S53 | 23.54 | 2.54 | 1.54 | 56.00 | 83.73 | 5L12 |
| S54 | 47.97 | 0.24 | | | | |
| S55 | 17.16 | 1.97 | 1.50 | 70.00 | 21.25 | 5L13 |
| S56 | 20.90 | 0.86 | 1.92 | 21.00 | −21.13 | 5L14 |
| S57 | 13.32 | 1.67 (Wide-angle End) | | | −63.13 | |
| | | 5.85 (The First Middle End) | | | | |
| | | 13.25 (The Second Middle End) | | | | |
| | | 17.30 (Telephoto End) | | | | |
| S58 | 33.21 | 0.63 | 1.54 | 56.00 | −23.27 | 5L21 |
| S59 | 8.97 | 2.48 | | | | |
| S510 | −9.39 | 0.63 | 1.60 | 61.00 | −20.11 | 5L22 |
| S511 | −45.32 | 16.96 (Wide-angle End) | | | | |
| | | 12.78 (The First Middle End) | | | | |
| | | 5.39 (The Second Middle End) | | | | |
| | | 1.33 (Telephoto End) | | | | |
| S512 | 39.33 | 1.69 | 1.52 | 64.00 | 34.89 | 5L31 |
| S513 | −32.46 | 0.28 | | | | |
| S514 | ∞ | 2.90 | | | | ST5 |
| S515 | 22.10 | 2.33 | 1.52 | 64.00 | 59.16 | 5L32 |
| S516 | 78.06 | 0.10 | | | | |
| S517 | 19.23 | 2.07 | 1.76 | 52.00 | 60.24 | 5L33 |
| S518 | 31.97 | 0.18 | | | | |
| S519 | 13.74 | 1.31 | 1.52 | 64.00 | 133.42 | 5L35 |
| S520 | 16.62 | 4.02 | | | | |
| S521 | −35.21 | 0.83 | 1.85 | 24.00 | −17.94 | 5L34 |
| S522 | 25.85 | 3.46 (Wide-angle End) | | | | |
| | | 1.43 (The First Middle End) | | | | |
| | | 1.25 (The Second Middle End) | | | | |
| | | 5.58 (Telephoto End) | | | | |
| S523 | 24.76 | 4.10 | 1.54 | 56.00 | 17.58 | 5L41 |
| S524 | −14.20 | 15.31 (Wide-angle End) | | | | |
| | | 17.33 (The First Middle End) | | | | |
| | | 17.51 (The Second Middle End) | | | | |
| | | 13.18 (Telephoto End) | | | | |

The definition of aspheric surface sag z of each aspheric surface in Table 13 is the same as that of in Table 1, and is not described here again. In the fifth embodiment, the conic constant k and the aspheric coefficients A, B, C of each aspheric lens are shown in Table 14.

TABLE 14

| Surface | | | | |
|---|---|---|---|---|
| Number | k | A | B | C |
| S53 | 0 | 3.03E−06 | −5.46E−08 | −2.29E−10 |
| S54 | 0 | 1.03E−05 | −1.12E−07 | 8.21E−11 |
| S58 | 0 | −2.45E−05 | 1.40E−05 | −1.33E−07 |
| S59 | 0 | −1.46E−04 | 1.64E−05 | 7.07E−08 |
| S523 | 0 | −1.28E−04 | −1.93E−06 | 6.07E−08 |
| S524 | 0 | 5.87E−05 | −2.27E−06 | 5.82E−08 |

Table 15 shows the parameters and condition values for conditions (1), (2), (4)-(9) in accordance with the fifth embodiment of the invention. By satisfying the conditions (1), (2), (4)-(9), and the refractive power and surface shape in Table 13, which making the fifth embodiment is a preferred embodiment of the present invention.

TABLE 15

| | | | | | | | |
|---|---|---|---|---|---|---|---|
| rb | −32.46 | mm | dc | 4.02 | mm | db | 13.18 mm |
| fa | −23.27 | mm | rc | −35.21 | mm | ft | 71.17 mm |
| f3g | 21.84 | mm | fc | −20.11 | mm | fw | 16.73 mm |
| f34 | −63.13 | mm | Y | 3.4 | mm | f4g | 17.58 mm |

| | | | | | | |
|---|---|---|---|---|---|---|
| (rb/dc)/fw | −0.48 | mm⁻¹ | (db − fa)/rb | −1.12 | rc/(f3g − fc) | −0.84 |

| | | | | | | |
|---|---|---|---|---|---|---|
| (ft − fw)/dc | 13.54 | ft/(f34/dc) | −4.53 | mm | (rc/fa) − fw | −15.2 |

| | | | | |
|---|---|---|---|---|
| (fc/Y) × f4g | −104 | mm | ft/fw | 4.25 |

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising a first lens group, a second lens group, a third lens group, and a fourth lens group, wherein:
the first lens group, the second lens group, the third lens group, and the fourth lens group are arranged in order from an object side to an image side along an optical axis;
the first lens group is with positive refractive power and comprises a 1-1 lens, a 1-2 lens, a 1-3 lens, and a 1-4 lens, wherein the 1-1 lens is with positive refractive power and comprises a concave surface facing the image side and being the lens closest to the object side, the 1-2 lens is adjacent to the 1-1 lens and has positive refractive power, the 1-3 lens is with refractive power and comprises a convex surface facing the object side, the 1-4 lens is with refractive power and comprises a concave surface facing the image side, and the 1-1 lens, the 1-2 lens, the 1-3 lens, and the 1-4 lens are arranged in order from the object side to the image side along the optical axis;
the second lens group is with negative refractive power and comprises a 2-2 lens, wherein the 2-2 lens is with negative refractive power and comprises a concave surface facing the object side;
the third lens group is with positive refractive power and comprises a 3-3 lens and a 3-4 lens, wherein the 3-3 lens is with positive refractive power, the 3-4 lens is a biconcave lens with negative refractive power and comprises a concave surface facing the object side and another concave surface facing the image side, and the 3-3 lens and the 3-4 lens are arranged in order from the object side to the image side along the optical axis; and
the fourth lens group is with positive refractive power and comprises a 4-1 lens, wherein the 4-1 lens is a biconvex lens with positive refractive power and comprises a convex surface facing the object side and another convex surface facing the image side.

2. The lens assembly as claimed in claim 1, wherein:
the third lens group further comprises a 3-1 lens and a 3-2 lens;
the 3-1 lens is the lens closest to the object side among the third lens group and the 3-4 lens is the lens closest to the image side among the third lens group;
the 3-2 lens is a meniscus lens; and
the 3-2 lens is adjacent to the 3-3 lens and is disposed between the 3-1 lens and the 3-3 lens.

3. The lens assembly as claimed in claim 1, wherein the lens assembly satisfies at least one of following conditions:
−92 mm⁻¹≤(rb/dc)/fw≤2 mm⁻¹;
−1.5≤(db−fa)/rb≤0.8;
−7.4≤(ra−rc)/ft≤5.4;
−9.76≤rc/(f3g−fc)≤−0.76;
10≤(ft−fw)/dc≤26;
−7.5 mm≤ft/(f34/dc)≤−2 mm;
−15.7≤(rc/fa)−fw≤−1.7;
−104 mm≤(fc/Y)×f4g≤−60 mm;
3.8≤ft/fw≤4.9;
−30 mm≤(ra/fb)×dc≤1.5 mm;
wherein rb is a radius of curvature of an image side surface of the lens which is between the object side and a stop and closest to the stop, dc is an interval along the optical axis from an image side surface of the lens which is among the third lens group and second closest to the image side to an object side surface of the lens which is among the third lens group and closest to the image side, db is an interval from an image side surface of the 4-1 lens to an image plane along the optical axis when the lens assembly is at a telephoto end, fa is an effective focal length of the 2-1 lens, rc is a radius of curvature of the object side surface of the lens which is closest to the image side and among the third lens group, ft is an effective focal length of the lens assembly when the lens assembly is at the telephoto end, f3g is an effective focal length of the third lens group, fc is an effective focal length of the lens which is closest to the image side and among the second lens group, fw is an effective focal length of the lens assembly when the lens assembly is at a wide-angle end, f34 is a combined effective focal length of the combination of the 1-3 lens and the 1-4 lens, Y is a maximum image height of the lens assembly, f4g is an effective focal length of the fourth lens group, ra is a radius of curvature of an image side surface of the lens which is with positive refractive power and among the second lens group, and fb is an effective focal length of the lens which is with positive refractive power and among the second lens group.

4. The lens assembly as claimed in claim 1, wherein:
the third lens group further comprises a 3-1 lens and a 3-2 lens;
the 3-1 lens is the lens closest to the object side among the third lens group and the 3-4 lens is the lens closest to the image side among the third lens group;
the 3-1 lens is a biconvex lens with positive refractive power and comprises a convex surface facing the object side and another convex surface facing the image side, the 3-2 lens is a meniscus lens, and the 3-3 lens is a meniscus lens; and
the 3-2 lens is adjacent to the 3-3 lens and is disposed between the 3-1 lens and the 3-3 lens.

5. The lens assembly as claimed in claim 4, wherein:
the 3-2 lens is with positive refractive power and comprises a convex surface facing the object side and a concave surface facing the image side;
the 3-3 lens comprises a convex surface facing the object side and a concave surface facing the image side; and
the lens groups comprise at least seven meniscus lenses.

6. The lens assembly as claimed in claim 1, wherein:
the 1-1 lens is a meniscus lens which is closest to the object side and the 1-1 lens further comprises a convex surface facing the object side;
the 1-2 lens is a meniscus lens; and
there is an air gap among the 1-1 lens, the 1-2 lens, and the 1-3 lens.

7. The lens assembly as claimed in claim 6, wherein:
the 1-2 lens comprises a convex surface facing the object side and a concave surface facing the image side;
there is no air gap among the 1-3 lens and the 1-4 lens, or the 1-3 lens and the 1-4 lens are cemented, and the combination of the 1-3 lens and the 1-4 lens is with negative refractive power.

8. The lens assembly as claimed in claim 1, wherein the second lens group further comprises a 2-1 lens which is with negative refractive power and comprises a convex surface facing the object side and is disposed between the 2-2 lens and the object side, and the 2-1 lens is a meniscus lens and further comprises a concave surface facing the image side; and
the second lens group moves along the optical axis toward the image side and the fourth lens group moves along the optical axis toward the object side or the image side when the lens assembly zooms, and the fourth lens group is the lens group closest to the image side.

9. The lens assembly as claimed in claim 8, wherein:
the 2-2 lens is a meniscus lens or a biconcave lens;
the 2-2 lens further comprises a convex surface facing the image side when the 2-2 lens is a meniscus lens; and
the 2-2 lens further comprises another concave surface facing the image side when the 2-2 lens is a biconcave lens.

10. The lens assembly as claimed in claim 9, wherein the lens assembly further comprises a meniscus lens which is with positive refractive power and comprises a convex surface facing the object side and a concave surface facing the image side and is disposed between the 2-1 lens and the 2-2 lens, or between the 3-3 lens and the 3-4 lens.

11. The lens assembly as claimed in claim 9, wherein the second lens group further comprises a 2-3 lens which is a biconvex lens with positive refractive power and comprises a convex surface facing the object side and another convex surface facing the image side and is disposed between the 2-1 lens and the 2-2 lens.

12. A lens assembly comprising a first lens group, a second lens group, a third lens group, and a fourth lens group, wherein:
the first lens group, the second lens group, the third lens group, and the fourth lens group are arranged in order from an object side to an image side along an optical axis;
the first lens group is with positive refractive power and comprises a 1-1 lens, a 1-2 lens, a 1-3 lens, and a 1-4 lens, wherein the 1-1 lens is with positive refractive power and comprises a concave surface facing the image side and being the lens closest to the object side, the 1-2 lens is adjacent to the 1-1 lens and has positive refractive power, the 1-3 lens is with refractive power and comprises a convex surface facing the object side, the 1-4 lens is with refractive power and comprises a concave surface facing the image side, and the 1-1 lens, the 1-2 lens, the 1-3 lens, and the 1-4 lens are arranged in order from the object side to the image side along the optical axis;
the second lens group is with negative refractive power and comprises a 2-2 lens, wherein the 2-2 lens is with negative refractive power and comprises a concave surface facing the object side;
the third lens group is with positive refractive power and comprises a 3-3 lens and a 3-4 lens, wherein the 3-3 lens is with refractive power, the 3-4 lens is a biconcave lens with negative refractive power and comprises a concave surface facing the object side and another concave surface facing the image side, and the 3-3 lens and the 3-4 lens are arranged in order from the object side to the image side along the optical axis; and
the fourth lens group is with positive refractive power and comprises a 4-1 lens, wherein the 4-1 lens is a biconvex lens with positive refractive power and comprises a convex surface facing the object side and another convex surface facing the image side;
the third lens group further comprises a 3-1 lens and a 3-2 lens, wherein the 3-1 lens is the lens closest to the object side among the third lens group and the 3-4 lens is the lens closest to the image side among the third lens group, and the 3-2 lens is a meniscus lens; and
the 3-2 lens is adjacent to the 3-3 lens and is disposed between the 3-1 lens and the 3-3 lens.

13. The lens assembly as claimed in claim 12, wherein the lens assembly satisfies at least one of following conditions:
−92 mm⁻¹≤(rb/dc)/fw≤2 mm⁻¹;
−1.5≤(db−fa)/rb≤0.8;
−7.4≤(ra−rc)/ft≤5.4;
−9.76≤rc/(f3g−fc)≤−0.76;
10≤(ft−fw)/dc≤26;
−7.5 mm≤ft/(f34/dc)≤−2 mm;
−15.7≤(rc/fa)−fw≤−1.7;
−104 mm≤(fc/Y)×f4g≤−60 mm;
3.8≤ft/fw≤4.9;
−30 mm≤(ra/fb)×dc≤1.5 mm;
wherein rb is a radius of curvature of an image side surface of the lens which is between the object side and a stop and closest to the stop, dc is an interval along the optical axis from an image side surface of the lens which is among the third lens group and second closest to the image side to an object side surface of the lens which is among the third lens group and closest to the image side, db is an interval from an image side surface of the 4-1 lens to an image plane along the optical axis when the lens assembly is at a telephoto end, fa is an effective focal length of the 2-1 lens, rc is a radius of curvature of the object side surface of the lens which is closest to the image side and among the third lens group, ft is an effective focal length of the lens assembly when the lens assembly is at the telephoto end, f3g is an effective focal length of the third lens group, fc is an effective focal length of the lens which is closest to the image side and among the second lens group, fw is an effective focal length of the lens assembly when the lens assembly is at a wide-angle end, f34 is a combined effective focal length of the combination of the 1-3 lens and the 1-4 lens, Y is a maximum image height of the lens assembly, f4g is an effective focal length of the fourth lens group, ra is a radius of curvature of an image side surface of the lens which is with positive refractive power and among the second lens group, and fb is an effective focal length of the lens which is with positive refractive power and among the second lens group.

14. The lens assembly as claimed in claim 12, wherein:
the 3-1 lens is a biconvex lens with positive refractive power and comprises a convex surface facing the object side and another convex surface facing the image side, and the 3-3 lens is a meniscus lens; and
the 3-2 lens is with positive refractive power and comprises a convex surface facing the object side and a concave surface facing the image side;
the 3-3 lens comprises a convex surface facing the object side and a concave surface facing the image side;
the lens groups comprise at least seven meniscus lenses.

15. The lens assembly as claimed in claim 12, wherein:
the 1-1 lens is a meniscus lens which is closest to the object side and the 1-1 lens further comprises a convex surface facing the object side;
the 1-2 lens is a meniscus lens;
there is an air gap among the 1-1 lens, the 1-2 lens, and the 1-3 lens;
the 1-2 lens comprises a convex surface facing the object side and a concave surface facing the image side; and
there is no air gap among the 1-3 lens and the 1-4 lens, or the 1-3 lens and the 1-4 lens are cemented, and the combination of the 1-3 lens and the 1-4 lens is with negative refractive power.

16. The lens assembly as claimed in claim 12, wherein:
the second lens group further comprises a 2-1 lens which is with negative refractive power and comprises a convex surface facing the object side and is disposed between the 2-2 lens and the object side, and the 2-1 lens is a meniscus lens and further comprises a concave surface facing the image side;
the 2-2 lens is a meniscus lens or a biconcave lens;
the 2-2 lens further comprises a convex surface facing the image side when the 2-2 lens is a meniscus lens;
the 2-2 lens further comprises another concave surface facing the image side when the 2-2 lens is a biconcave lens; and
the second lens group moves along the optical axis toward the image side and the fourth lens group moves along the optical axis toward the object side or the image side when the lens assembly zooms, and the fourth lens group is the lens group closest to the image side.

17. The lens assembly as claimed in claim 16, wherein the lens assembly further comprises a meniscus lens which is with positive refractive power and comprises a convex surface facing the object side and a concave surface facing the image side and is disposed between the 2-1 lens and the 2-2 lens, or between the 3-3 lens and the 3-4 lens.

18. The lens assembly as claimed in claim 16, wherein the second lens group further comprises a 2-3 lens which is a biconvex lens with positive refractive power and comprises a convex surface facing the object side and another convex surface facing the image side and is disposed between the 2-1 lens and the 2-2 lens.
